(19) United States
(12) Patent Application Publication
(10) Pub. No.: US 2018/0311594 A1
(43) Pub. Date: Nov. 1, 2018

(54) DEVICE FOR THE CONVERSION OF NON POTABLE WATER INTO ECOLOGICAL DRINKING WATER

(71) Applicant: FOTIOS TSAGAS, XANTHI (GR)

(72) Inventors: IOANNIS TSAGKAS, XANTHI (GR); NICOLAOS TSAGAS, XANTHI (GR)

(21) Appl. No.: 15/770,324

(22) PCT Filed: Oct. 26, 2016
(86) PCT No.: PCT/GR2016/000057

§ 371 Date: Apr. 23, 2018

(30) Foreign Application Priority Data
Oct. 27, 2015 (GR) 20150100463

(51) Int. Cl. B01D 3/34; B01D 1/00; B01D 3/42; B01D 5/00; C02F 1/04; B01D 1/28

(52) U.S. Cl. CPC B01D 3/346; B01D 1/0023; B01D 3/42; C02F 1/043; B01D 5/006; C02F 1/041; B01D 1/28; B01D 5/0003

(57) ABSTRACT

The invention includes: 1. One or more stainless boiling chambers 2. Mechanisms for low cost heat production, 3. Mechanisms channeling air molecules flow into the non potable water chambers or mechanisms absorbing air from the drinking water chambers and other chambers and mechanisms of the system, through folded long and spacious tube in a grid shape or in the form of cyclic coil, thus reducing water vapor pressure [BERNOULLI], lowering boiling temperature and increasing evaporation rate, 4. An intermediate chamber to separate water vapor from the droplets of non-drinking water, 5. A tank to feed boiling chambers 6. A single or dual function thermostat or a system of two thermostats, 7. Ion trapping mechanism, 8. Mechanisms for cooling, refrigeration, compression, ice packs and fans to condense water vapor, 9. An electromagnetic valve, or a tubular electropump, when the feed of water is incapable, level limit sensors, electromagnetic switch, electrical relays, timer, power supply switch, optical isolators, power amplifier, 10. Mechanism with a diode (single passage) valve and float (floater) 11. Water vapor transport mechanisms, 12. Collection chambers for drinking water, 13. Expansion (discharge-relief) and non-return valves, 14. Mechanism adding magnesium, potassium and other elements, 15. Mechanism for exit (extraction) of the brine 16. A microprocessor or microcontroller that coordinates the operation of the system. Generally (overall), this device that converts non potable water into ecological potable (drinking) water presents (displays) great potential, (outlook) which can be done in order to be environmentally friendly with less thermal pollution and waste, without using any filters or membranes, since whatsoever, it can produce potable water, respecting (abiding) all hygienic conditions and requirements.

### FIELD OF THE INVENTION

The Proposed Conversion Device of Non Potable Water into Ecological Drinking Water, according to the present invention includes: chambers for boiling and rapid evaporation of non-potable water, with a limit temperature set at <100° C., mechanisms for rapid and low cost heating, mechanisms of adjustable speed that channel rapid air molecule flow, inside the chambers and the mechanisms of the proposed device, increasing the escape rate of water vapor, resulting in reduced pressure on the boiling surface according to the principle of D.BERNOULLI which involves the drop of water boiling temperature and the increase of evaporation rate, a network of stainless piping or multinetwork polyethylene piping, a chamber for the separation of water vapor from the droplets of the non-potable water,cooling and compression mechanisms for the condensation(liquefaction) of water vapor, non-return and discharge valves (antiepistrofis and relief valves), a reservoir for filling the heating chambers with water(tank to fill with water the boiling chambers), control sensors for the limits of water level, an automatic non return valve with floater for filling the chamber with non-potable water for boiling, a timer, a switch mechanism for electric power switching or supply to one of the rapid and economic heating mechanisms, an electromagnetic valve with an electromagnetic switch and an integrated circuit with a power amplifier, simple thermostats or bifunctional, filling chambers for drinking water, mechanisms that compress and transfer non-liquefied water vapor to boiling chambers, ion trapping mechanism, and a microprocessor, wherein the operation of the proposed device is based on the separation of water vapor from the droplets of the non-drinking water and on the BERNOULLI principle, by which the product of the water vapor pressure multiplied by the speed is constant, resulting in reduced pressure and boiling temperature of water along with increased evaporation rate. Moreover, the air flow by mechanism towards the drinking water collection chamber reduces the water vapor temperature, participating in their liquefaction and enriching the produced drinking water with beneficial elements. The water is further treated by adding useful elements.

### DESCRIPTION OF THE EXISTING TECHNOLOGY

A) Evaporation-condensation(liquefaction) methods with the aid of heating-cooling. These methods rely on the fact thk the water is vaporized by boiling at the temperature of 100° C. or more, which is then liquefied by cooling water. In these methods, the thermal energy is of high cost. B) Method of electrolysis. The dissolved salts in the form of ions move, under the influence of the electric field, to the electrodes resulting in reduced salt concentration in the remaining solution. Electrolysis, apart from the large amount of electricity spent, uses high-cost membranes (films), and the remaining water contains only a smaller amount of salt. C) Method of reverse osmosis. Semipermeable membranes allow the transit(passage) of water through a solution with salts, but do not allow the transit of dissolved salts. The water is separated through (by) the membranes, from the dissolved components it contains, with pressure for which spent considerable amount of energy. The method uses filters and high-cost membranes, (films) to destroy microorganisms, in addition to the necessary use of chemicals which pollute the environment. D) Method of producing drinking water by solar energy reduces significantly the cost. The efficiency of solar stills(retorts) is determined by weather conditions, humidity, speed, latitude, the winds and vapors defining and daily sunshine in the region. Investing on drinking water production technologies with solar energy is recommended (appropriate) for some areas with lots (ample) sunshine, while for typical (standard) areas, the water production is approximately 1 m³/m² of surface, on an annual basis. E) Other drinking water production technologies. Several other technologies have also been developed; which are based on different operating principle, but have not been widely established, due to non-effective performance, and therefore will not be mentioned.

### DRAWBACKS OF THE EXISTING TECHNOLOGY

Said systems present (display) several disadvantages, which depending on the type of the method are summarized as follows: a). A significant part of the thermal energy is not recycled for reuse but discharged and charged heat to the environment, b) Membranes and filters have a relatively short life and high cost, c) A total elimination of salts is never achieved in the produced water, a small amount remains, d). The yield in said systems is small, e). For cleaning (purification) the membranes and the destruction of microorganisms, use is made of chemicals which is then discharged and pollute the environment.

### SUMMARY OF INVENTION

The first aim of this invention is to provide a device that has the lowest manufacturing and installation costs, which can produce economical ecological clean drinking water by using low-cost electricity and finally be able to become functionally reliable and generally useful. Its secondary purpose is to provide a device that can be used, either by large numbers of users, in cases where water is scarce or of dubious quality, such as communities, islands, boats, etc, or by a small number of users, such as the members of a family. The third purpose is to provide a device that produces drinking water, in a user-friendly manner and under all hygiene requirements.

The first objective can be realized by means of devices, mechanisms and components of the existing technology, greatly reducing the cost of the system, as a chamber including an inlet for non-potable water deriving from the reservoir, with the aid of a mechanism comprising of an electromagnetic valve with an electromagnetic switch and an integrated circuit with a power amplifier or a non return valve with a floater to automatically fill the chamber with water up to the maximum water level limit, monitoring the selected limits and the exit of water vapor with sensors and mechanisms, a pressure gauge, the mechanisms for rapid and low cost heating, aiming at boiling water at temperatures <100° C., depending on the water vapor pressure on the water surface which is decreased because of the high water vapor escape rate from the outlet of the heating chamber, when blown air flow within the heating chamber, and into the pipe network, towards the same direction with the vapor, increasing the speed of the water vapor, thus reducing the pressure and lowering the boiling temperature, rapid refrigeration mechanisms with fan, cold air generating mechanism with multiturn fans, chambers to be filled with drinking water with a horizontal layer of materials suitable to improve its quality, outlet mechanisms of drinking water and further improvment, air intake devices for the chambers of potable and non-potable water, transport mechanisms for not liquefied water vapor into the heating chambers of non potable water, a microprocessor or a microcontroler to coordinate the operation of the whole system and other accessories, for the inexpensive production of drinking water. The second objective of the present invention can be implemented by means of a flexible system that, depending on the size of the mechanisms and their construction parts, can be used, either massively for a large numbers of users or by a small number of users. The third objective of the present invention can be implemented by means of the proposed device, so that to be environmentally friendly with less thermal pollution and waste, producing drinking water satisfying all hygiene requirements.

### BRIEF DESCRIPTION OF DRAWINGS

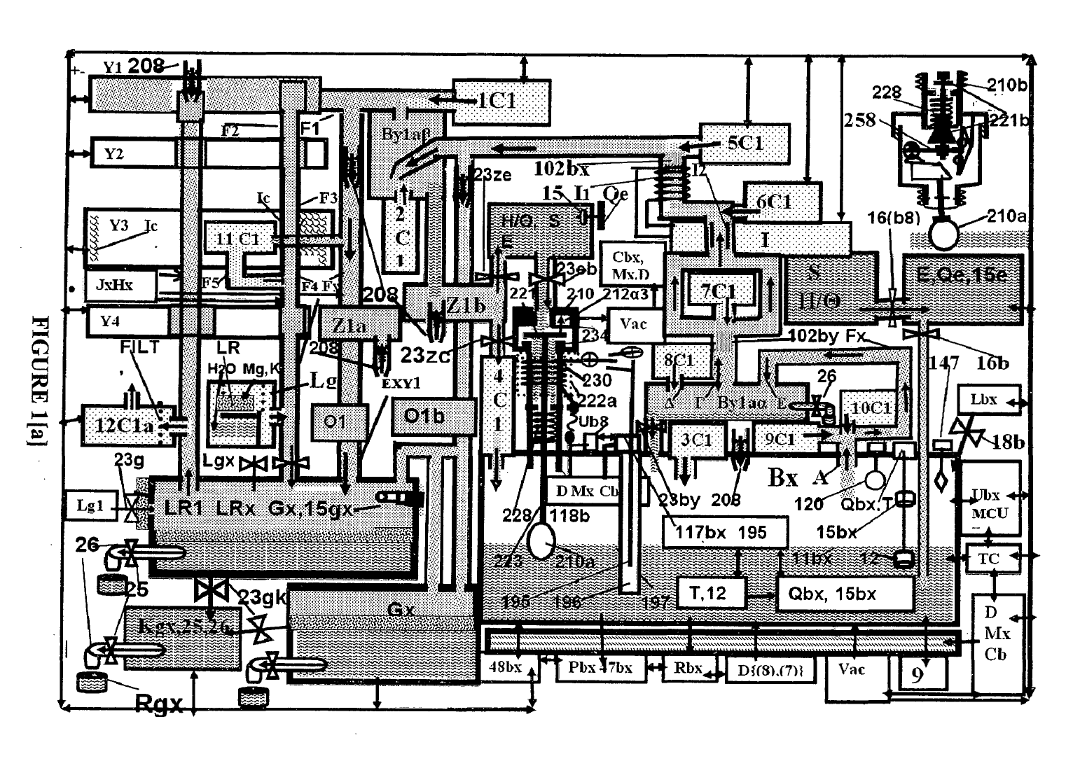

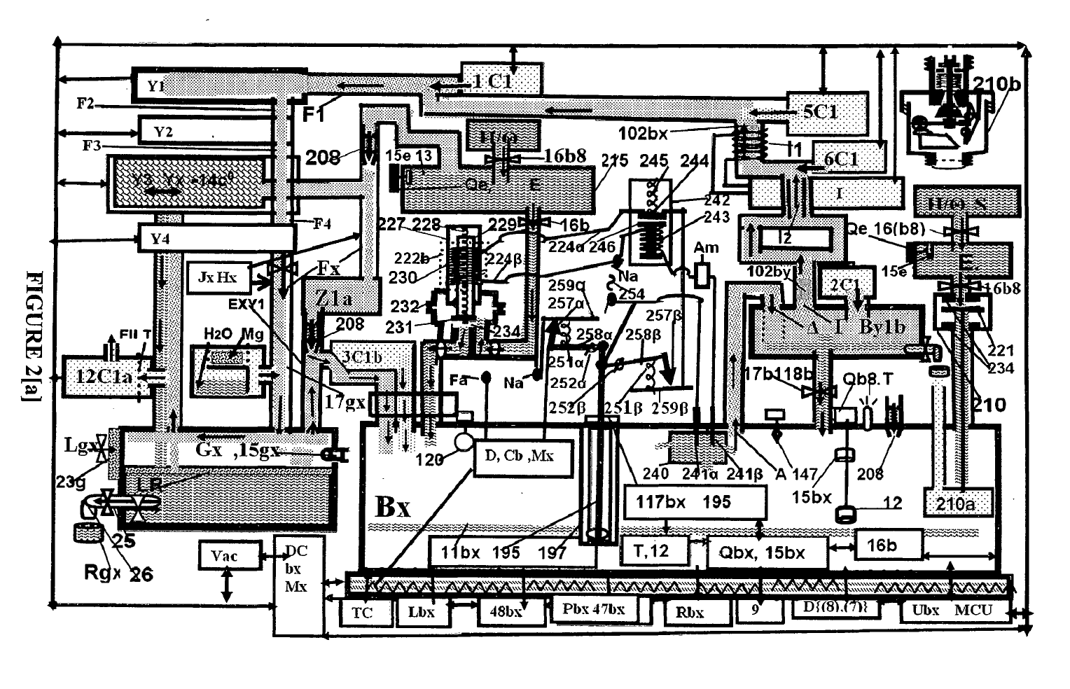

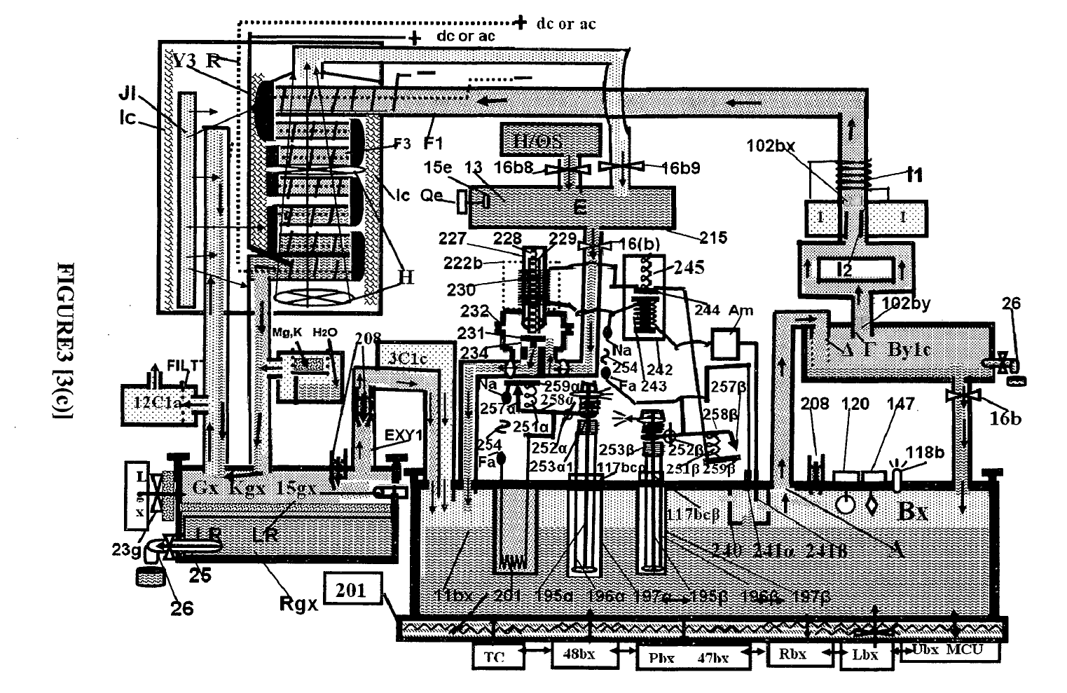

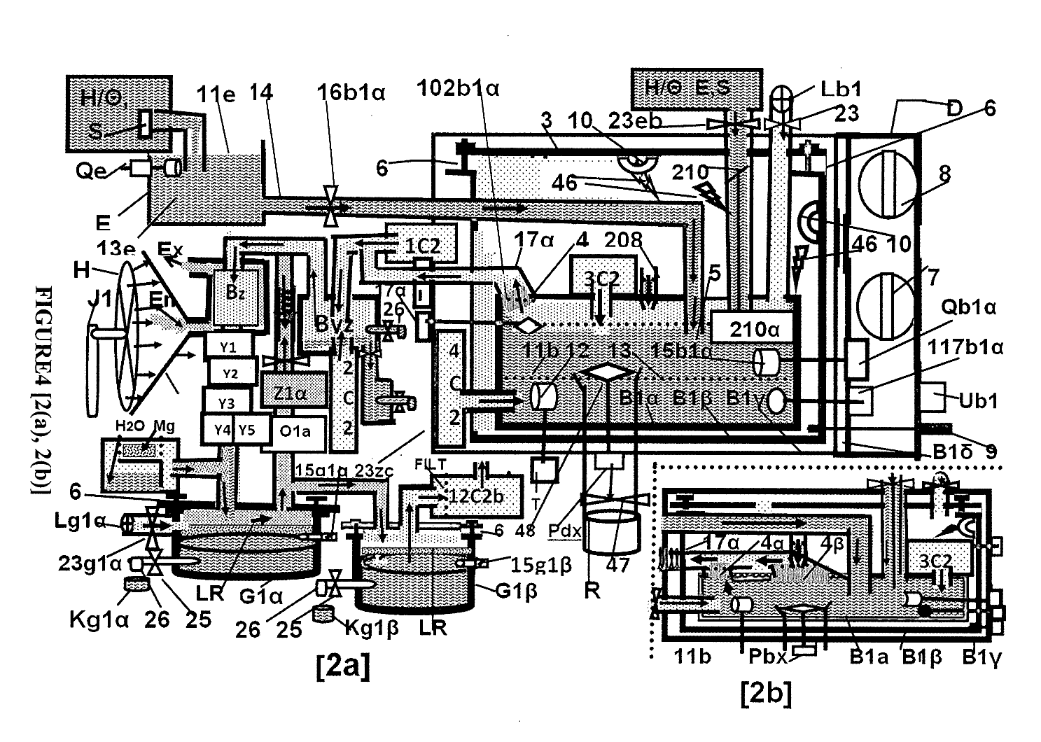

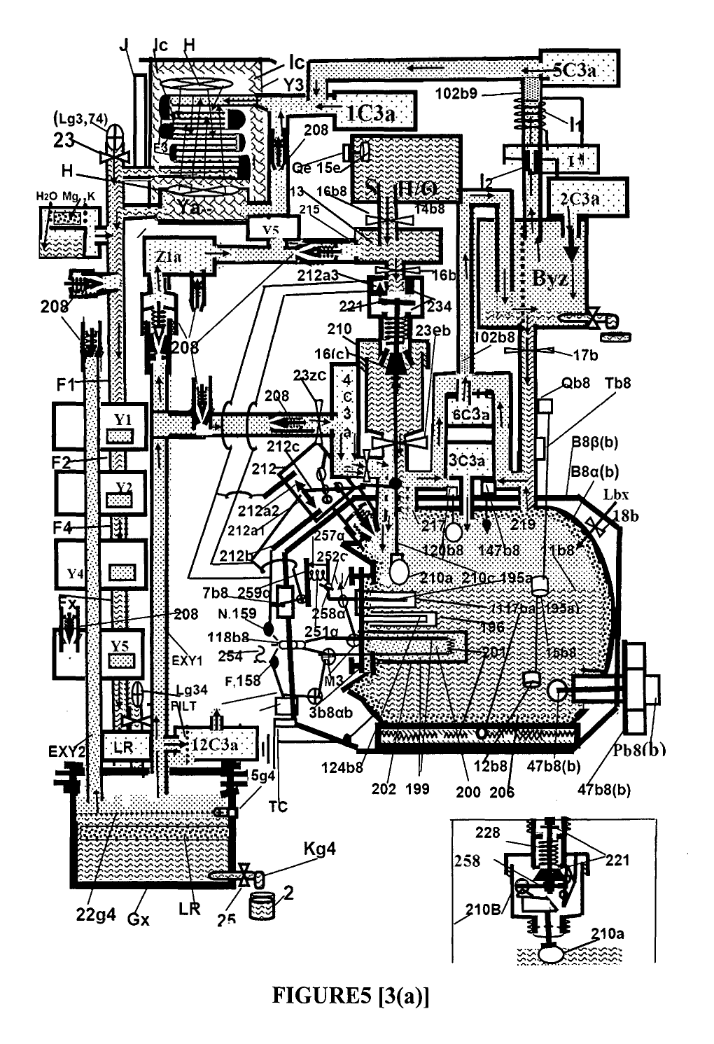

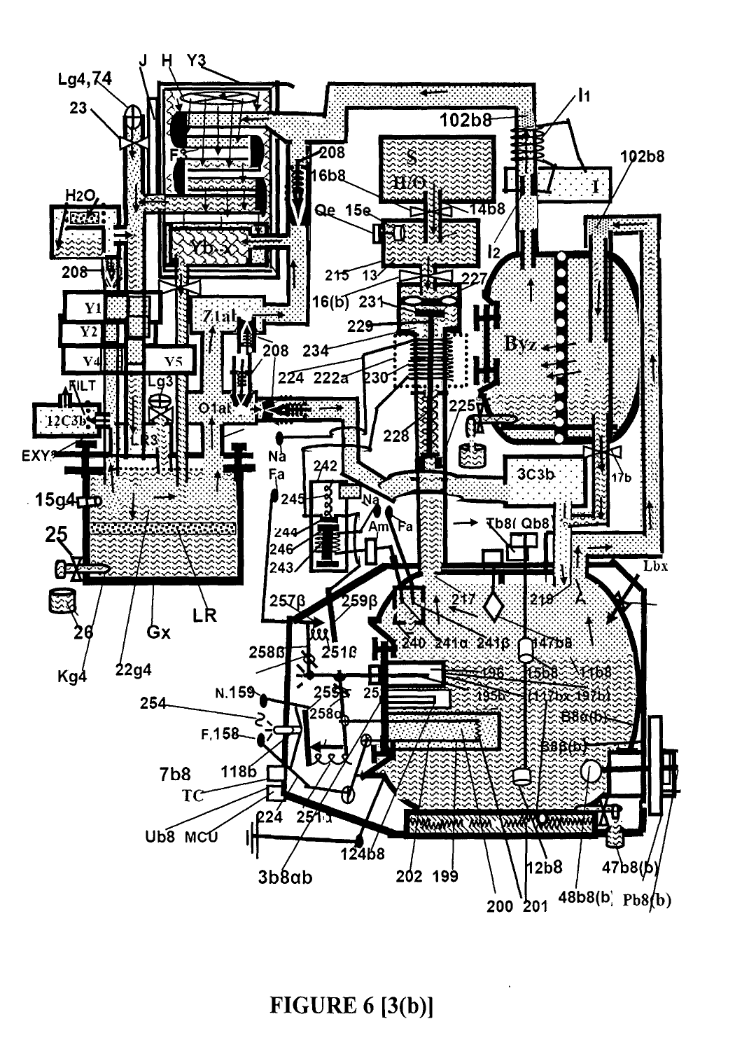

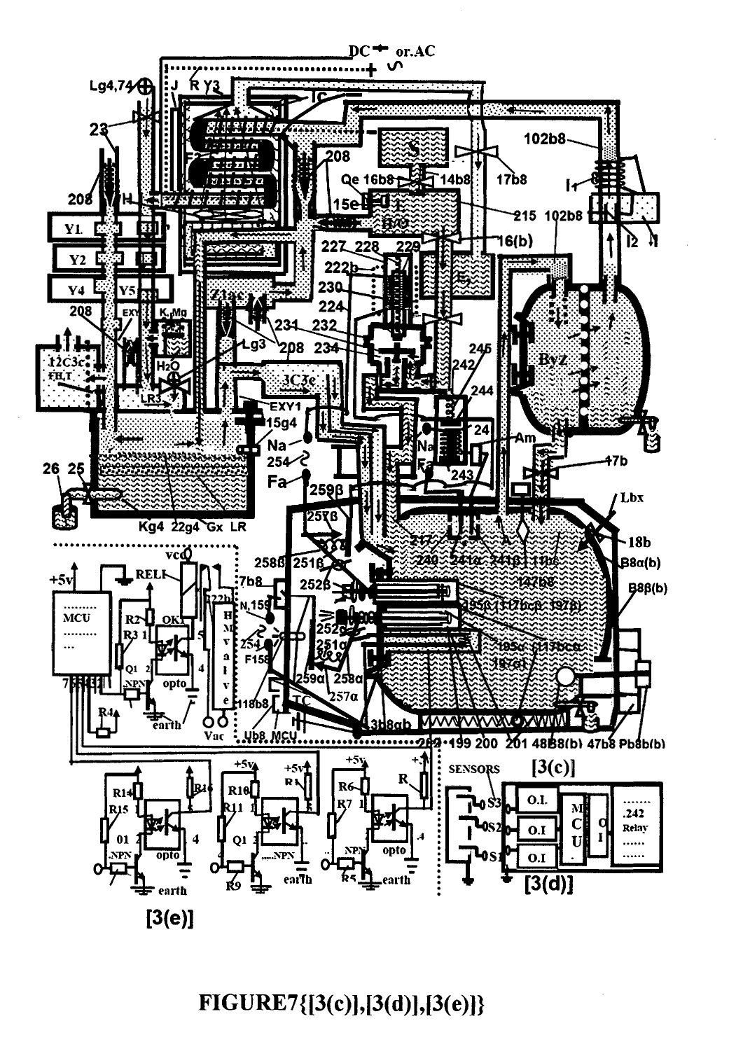

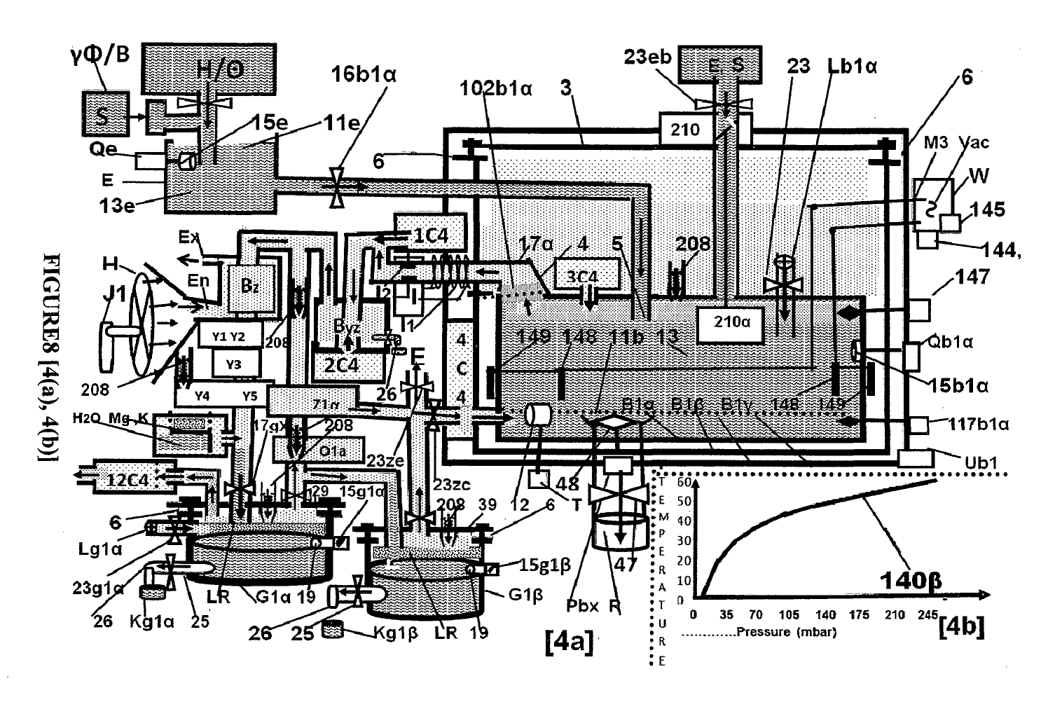

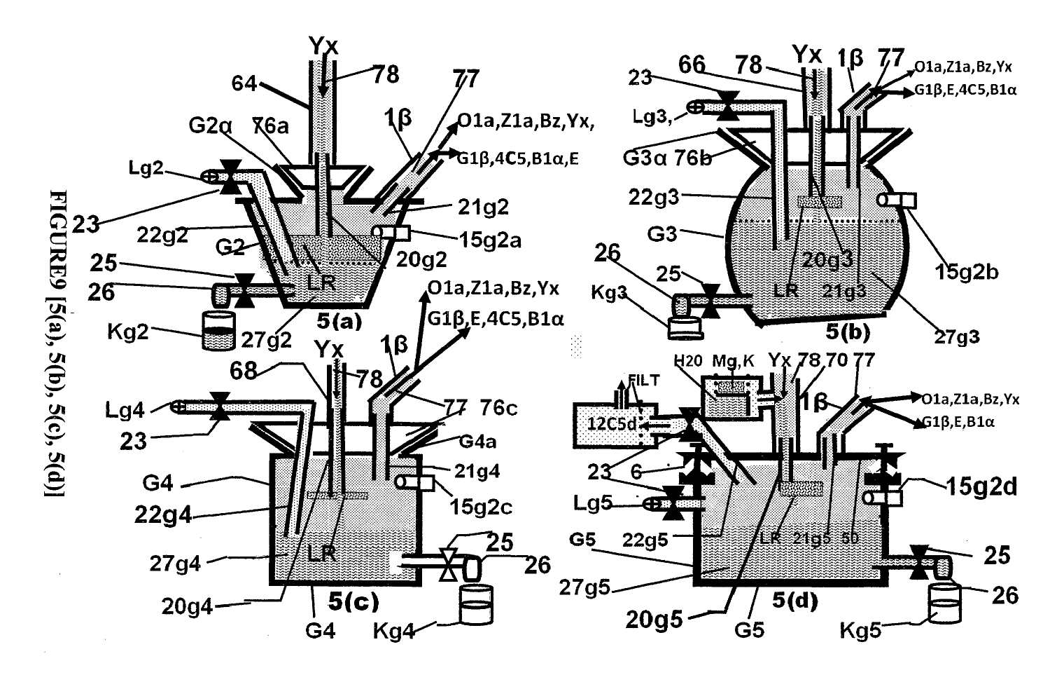

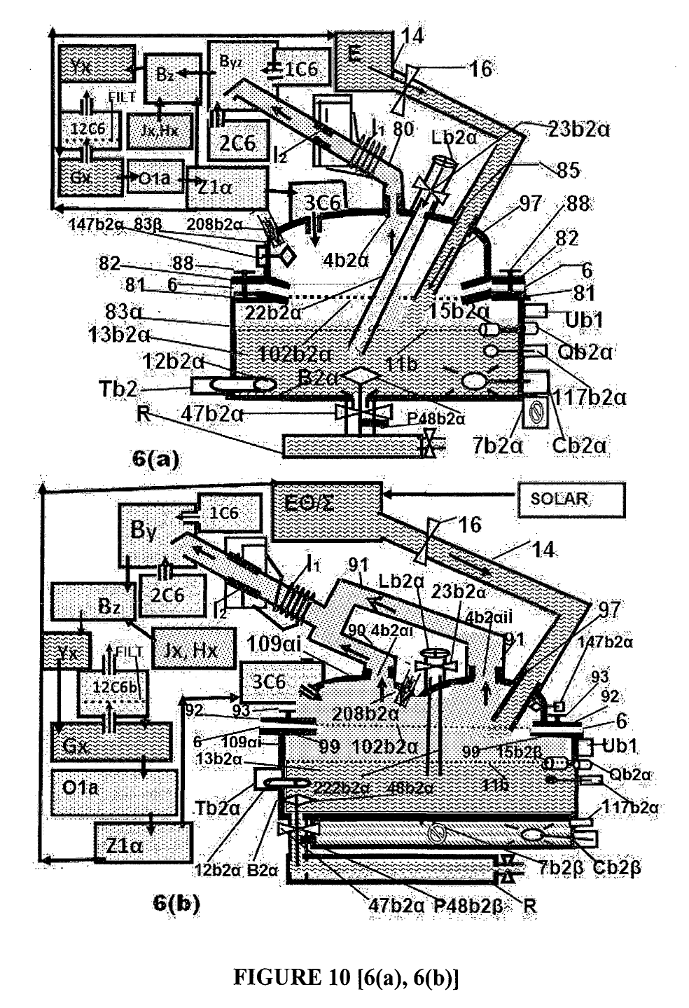

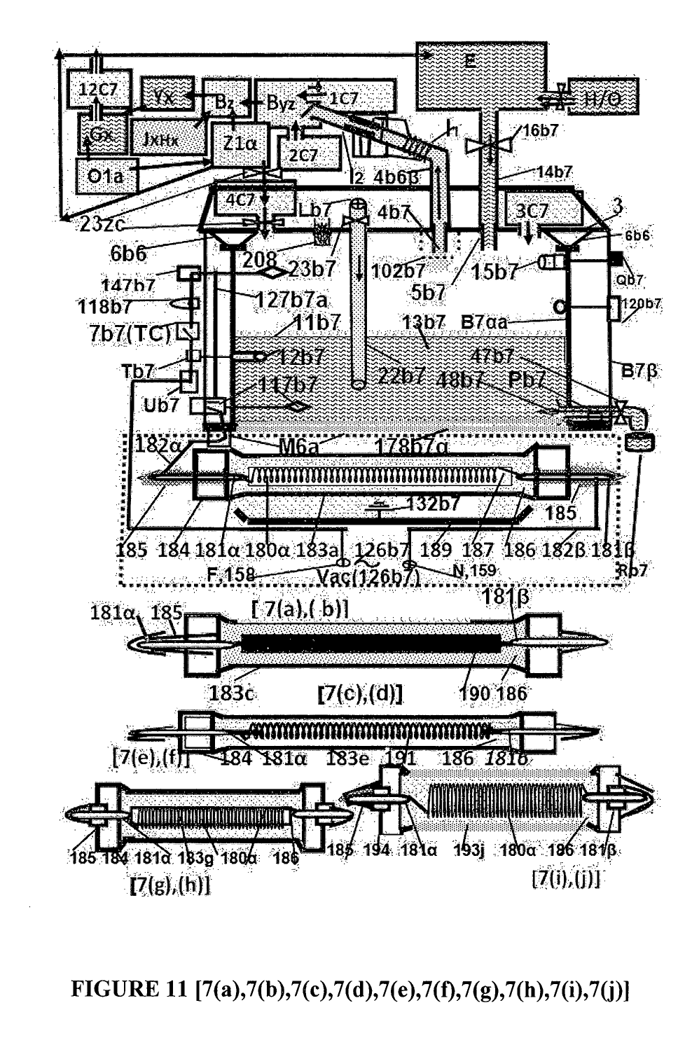

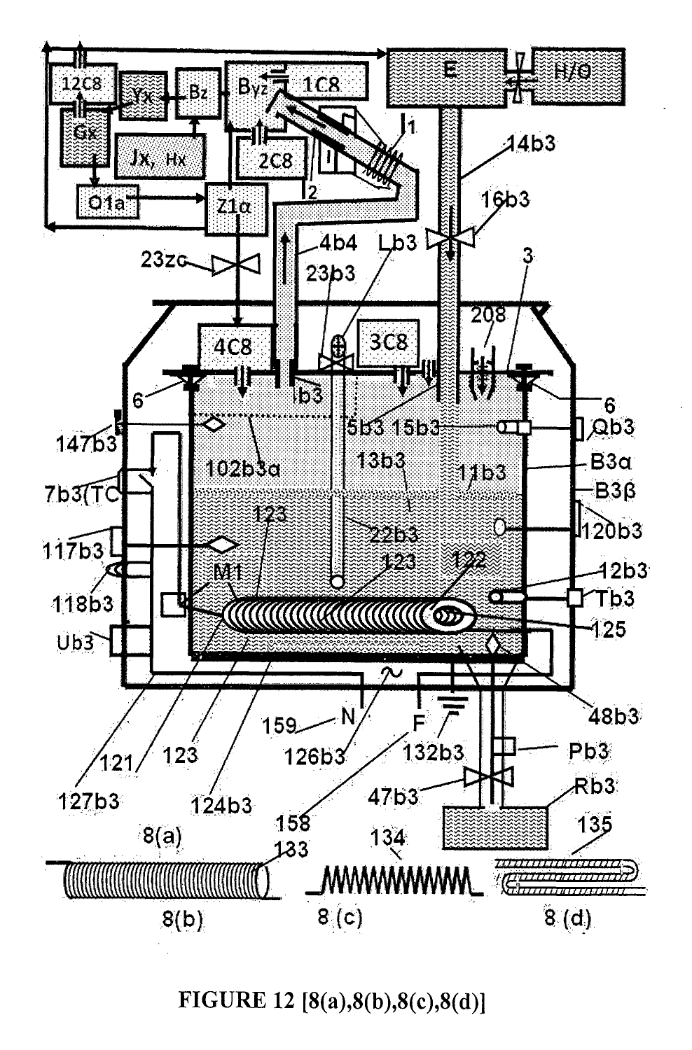

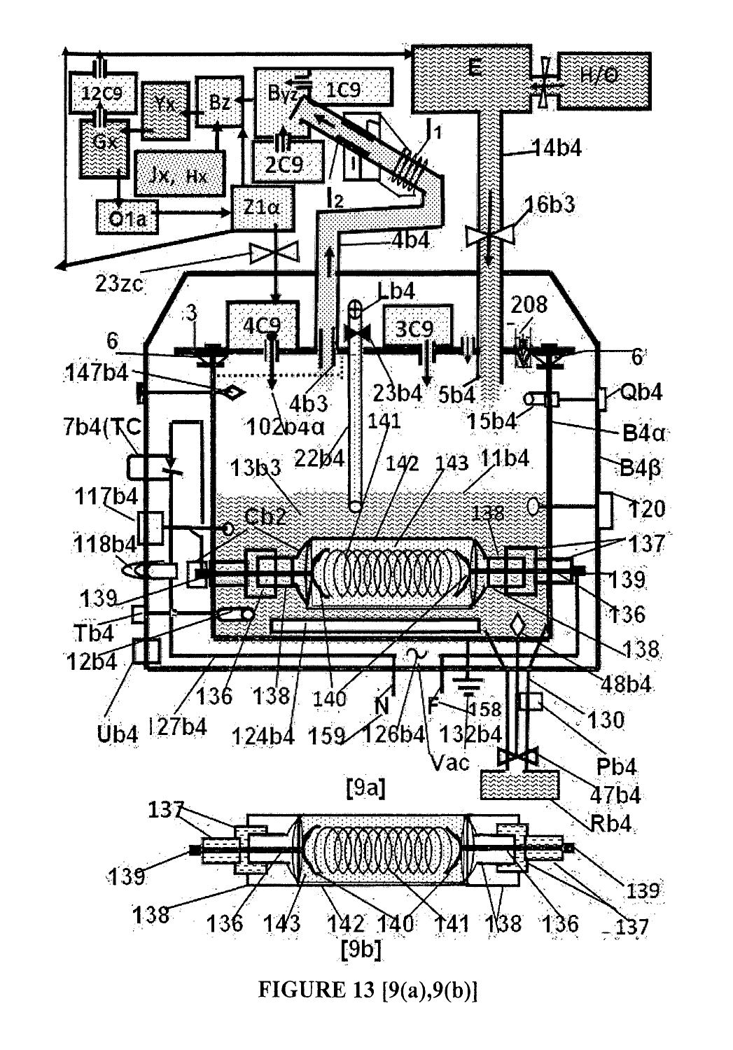

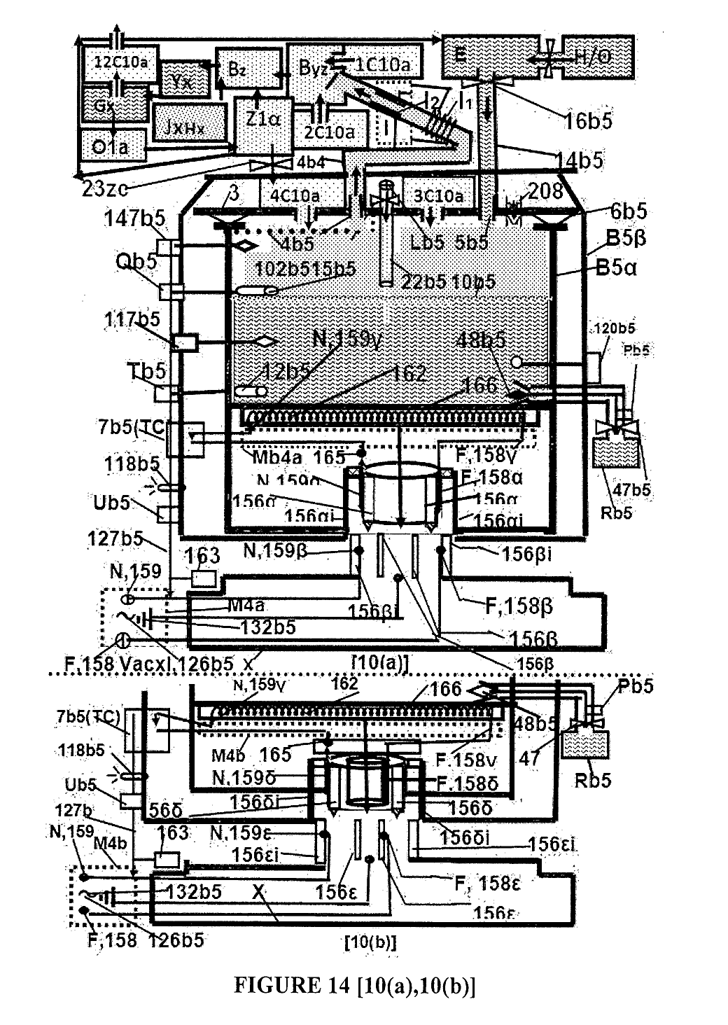

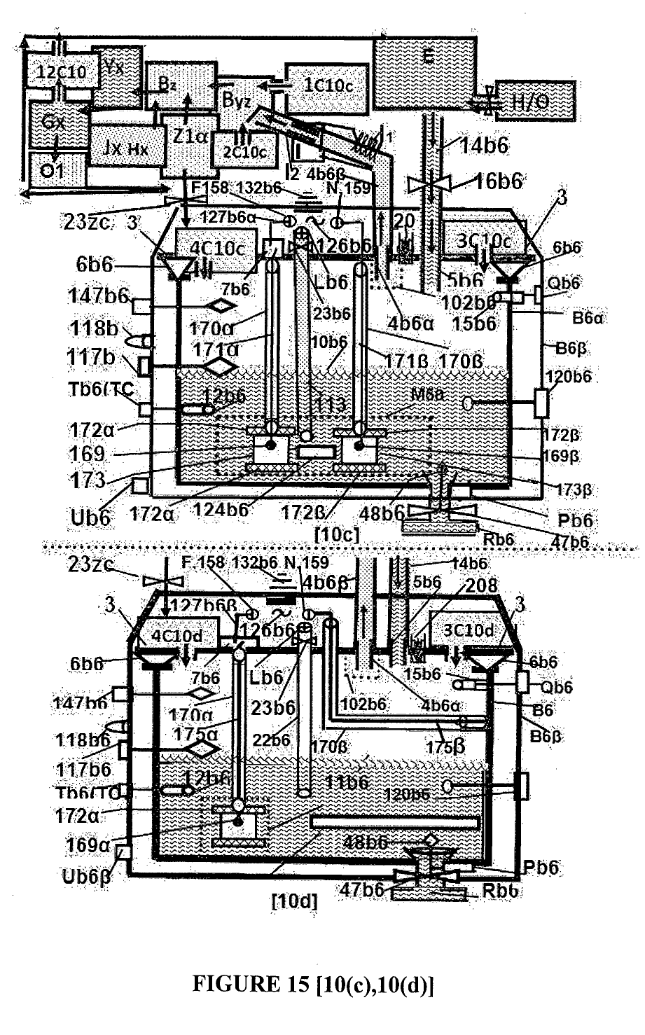

The application of the invention is described below with reference to the accompanying drawings, in which the above-mentioned objectivess and other innovative features of this invention will become clear to the experienced technologist experts who will examine it. FIG. 1 [1(a)] shows (depicts) a general view of a device for the conversion of non-potable water into ecological drinking water, which according to the present invention, is characterized in that it comprises of: several sections such as boiling chambers, air molecules flow and aspiration mechanisms (xC1) [x=1,2, . . . 11], water droplet from vapor separation chambers, valves, thermostats, floater mechanism, low cost heating mechanisms, water vapor liquefaction (condensation) mechanisms, timer, sensors, electromagnetic valve etc. FIG. 2 [1(b)] illustrates (depicts) a general view of the device characterized in that it comprises of: the mechanism (3C1b), the electromagnetic valve (222b), the sensor (240), the electromagnetic switch (242), the thermostat (117bx, 195b). FIG. 3 [1(c)] shows a simpled view of the device characterized in that it comprises of: the first thermostat (117bcα, 197α) interrupting the power and with the help of the second thermostat (117bcβ, 197β) and the electromagnetic valve (222b), the filling of (Bx) becomes possible, where upon reaching the lower threshold the (Pe) is interrupted, and (Y3) initiates to function. FIG. 4 [2(a)] presemts a specific view of the device characterized in that it comprises of: chambers (B1β), (B1α), (B1γ), mechanisms (xC2), microwave mechanism (D), valves, thermostat (117b1α), mechanism (210) with floater (210a), chambers (Byz), (Bz), (G1α) and (G1b), mechanisms (Yx). FIG. 4 [2(b)] is designed with two outlets (4α), (4β) for a larger outlet of water vapor. FIG. 5 [3(a)]. shows another view of the device characterized in that it comprises of: chambers (B8αb), (B8βb), the ohmic resistance (201), mechanisms (xC3a) for lowering the boiling temperature, mechanism (Y3) with ice packs (Ic), mechanism (210) with a floater (210a), the switch-mechanism (212), a thermostat (117b8). FIG. 6 [3(b)] shows another aspect of the system, which comprises of: an electromagnetic valve or solenoid (222a), the electromagnetic switch (242), the mechanisms (3C3b), (Lbx), the transmission tube (EXY1) of moisture vapor towards (B8ab), (Y3) and (Yb). FIG. 7 [3(c)] shows a simple view of the device characterized in that it comprises of: a mechanism (3C2c), two thermostats (117bcα, 197α), (117bcβ 197β) to tern off (Pe) and with the aid of the electromagnetic valve or solenoid (222b) to conduct the filling (B8αb) and the function of (Y3). FIG. 7 [3(d)] shows a complete water level control system (11bc) of the device which is characterized in that it comprises of: four optical isolators, three water level position sensors (11bc), the microcontroller MCU whose operation is programmed according to the input control for the activation of relay 1 (Relay1) and the electromagnetic filler valve (222b), wherein relay 1 controls the electromagnetic valve (222b) while relay 2 controls the resistance (201) for protection FIG. 7 [3(e)] shows a simple circuit which opens a valve when water contacts the sensor, and regulates the delay for the reopening of the valve. FIG. 8 [4(a)] shows another view of the device characterized in that it comprises of: a chamber (B1αa), a mechanism (M3) to provide (Pe), by applying Vac to two electrodes (148) inside (B1α) and to two electrodes (149) outside (B1α) for heating, achieved by the vibration of ions, wherein the pressure within (B1α) is controlled by mechanisms (3C4), (Lb1). In FIG. 8 [4(b)], the water boiling point is represented by curve (140β). FIG. 9, comprises of FIGS. 9 [5(a),5(b),5(c),5(d)], for further improvement and processing of drinking water collection, wherein the device comprises of: various chambers (G2), (G3), (G4), (G5), a tube (21gx) for the transport of not liquefied water vapor (77), towards (Bz), (Yx), (4C5), (B1a), (E). FIG. 10 [6(a)] shows another view of the device characterized in that it comprises of: chamber (B2α) with water vapor outlet to (Byz), (Bz) (Yx), and drinking water collection at (Gx), from (1C6) and (3C6) that channel air into (Byz) and (B2α) to reduce boiling temperature, (2C6) for separating water vapor from droplets, a thermostat (117b2α), a (Z1a) that transfers water vapor to (Bz), (Yx), (3C2a), (B2α), (E). FIG. 10 [6(b)], shows another aspect of the system, with two outlets (4b2βi), (4b2βii) for the outlet (escape) of larger quantities of water vapor. FIG. 11 [7(a)] shows another view of the device comprising of: chambers (B7b) and (B7αa), with common transparent bottom (178b7a) so that heating photons (radiation) reached the water, the heating mechanism (M6a), a heater (178b7α) to emit radiation from 1.3 μm to 3.1 μm, the reflector (189) for doubling radiation, the (2C7) for separating droplets. FIG. 11 [7(b)] depicts a heater inside the chamber (B7αb), identical with reference to FIG. 7(a). FIGS. 11 [7(c), 7(d)], show the same heater externally and internally of (B7αb), with a carbon rod (190), which when heated to 1000° C., responds within seconds. FIGS. 11 [7(e),7(f)] illustrate the same heater externally and internally of (B7αb) with carbon coil (191). FIGS. 11 [7(g),7(h)], illustrate the same heater externally and internally of (B7αb) with a ceramic rod (192). FIGS. 11 [7(i), 7(j)], show another view of the device which is characterized in that these settings include the same heater externally and internally of (B7αb) with a refractory ceramic tube (193) and coil (180) with wire (thread) made of W, (300° C.-700° C.). FIG. 12 [8(a)], comprises of: a heating mechanism (M1) by (amf) application, produced by the coil (121), to which Vac is applied, setting (a.r.m.) ions in water in vibration around (m1), causing an increase in temperature, wherein the mechanism (3C2a) channels air into the (B3α), thereby reducing the water vapor pressure. FIG. 12 [8(b)] shows a simple coil (133) not surrounding the hollow ceramic. FIG. 12 [8(c)] shows a conventional ohmic resistance (134). FIG. 12 [8(d)] shows another form of ohmic resistance (135). FIG. 13 [9(a)] shows another view of the device, comprising of: a heating mechanism (M2), which comprises (includes) a halogen lamp heater, in which thread made of W is embedded (141), to which Vac is applied and upon reaching incandescent temperature, electromagnetic radiation of wave length 2, 8μm is emitted, resulting in rapid production of water vapor, transferred through chamber (Byz) to (Bz), (Yx), (Jx) (Hx), while drinking water flows in (Gx), wherein mechanisms (3C9), (Lb4), (4C9), channel air with the remainder of the water vapor into chamber (B4α). FIG. 13 [(9b)] is FIG. 13 [(9a)] rotated around axis (136) by 90° degrees. FIG. 14 [10(a)] comprises of: the (B5β), (B5α),with bottom (166) heated by means of the ohmic resistance (162), mechanism (M4) providing (Pe) to (162), through the relay (165) and (TC), to heat the non-potable water in the (B5α), the (Bz) cooled by the cooling mechanisms (Jx) and fans (Hx), mechanisms (3C10) and (4C10) who channel air into (B5a) and water vapor thus reducing the boiling temperature. FIG. 14 [10(b)], is differentiated from FIG. 14 [10(a)], in the part of connections. FIG. 15 [10(c)] comprises of: chambers (B6β) and (B6α), on the bottom of which and onto two bases (172α) and (172β), two carbon electrodes (173α) and (173β)are placed, to which Vac is applied, setting ions within water to vibrate, resulting in the rapid heating of water in (B6a), the (3C10c) and (4C10c) which channel air into the (B6α) and water vapor. FIG. 15 [10(d)] comprises of: (B6β) and (B6α), where (B6α) is connected as an electrode to (N, 159), wherein at the bottom of (B6α), the (173α) is mounted on a base (172α), which is connected to the (F, 158) through (7b6), the (TC) where by closing the circuit Vac is applied between (173α) and (B6α), setting ions within water to vibrate, resulting in rapid heating of water, mechanisms (3C10d) and (4C10d) who channel air into (B6α) and water vapor.

### DETAILED DESCRIPTION OF THE PREFERRED INTEGRATED APPLIANCES

The detailed description of the preferred integrated appliances with reference to the accompanying drawings does not intend to limit the scope of the invention and it will be understood by an experienced technologist examiner that the present invention is not provided by the existing technology.

According to the first preferred integrated embodiment of the invention, illustrated in FIG. 1 [1(a)], the device for the conversion of non-potable water into ecological drinking water, is characterized in that it comprises of: one or more stainless chambers (Bx), with lid (cover) spacious access to the interior of the chamber, for heating, boiling and evaporation of non-potable water, with a limit boiling temperature set at <100° C., wherein the inner walls of (Bx) are coated with porcelain layer, and external walls are covered with insulating material, rapid and economic heating mechanisms (D), (Cbx), (Mx) for adjustable (controlled) heating, such as through microwaves for dielectric heating, with alternating rotary motion of ions in the water around the magnetic lines, with alternating electric and magnetic fields of different wave forms and frequencies, with electrical power (Pe) applied to an ohmic resistor, with vibration of the ions, by applying Vac to electrodes in the water, with emission of electromagnetic radiation to a peak of 2.8 μicrons, a network of stainless steel tubing, or multinetwork polyethylene pipes, chamber (By1aα) for droplets separation, water vapor condensation (liquefaction) mechanisms (Yx), with x=1,2,3,4,5 wherein (Y1) comprises of stainless pipe with cold fluid stream, through which coaxially runs tube (F1) filled with water vapor, (Y2) includes a cold fluid reservoir through which passes tube (F2) filled with water vapor, (Y3) includes a mechanism for rapid-deep freezing with an interior space filled by ice packs (Ic) of large heat capacity, through which space is passing (runs) a folded several-metre long and spacious tube (F3) filled with water vapor with folds, double, grid shaped, (streamers), device either on an horizontal or vertical surface or in the form (shape) of cyclic coil (thread) spiral-shaped with vertical axis,so as to avoid the accumulation of water wherein an electrically heated ohmic resistor (R) is placed inside and outside of (F3), to avoid (prevent) pipe blocking by ice, a fan (H) and at a minimum distance from (F3) below or above it, to accelerate the condensation of water vapor falling (running) heat and transport of hot air to the tank (E) where ice packs cover the internal walls of the mechanism (Y3) for shielding against overheating of the refrigerant gas and the electric motor of the freezer, and pipe blocking, as the operation of the freezer is interrupted by a thermostat in case of overheating, wherein the input and the output of (F3) into the inside of (Y3) is performed from the top or bottom side of the freezer, where the system can be simplified by the use of valves for manual filling of (Bx) and emptying of (Gx), bypassing the automatic double switch mechanisms, the (Y4) and (Y5) include compression chamber and mechanism via which passes piping (F4), (Fx) with water vapour, air cooling mechanisms (Jx) with the help of fans (Hx) towards piping (Fx), mechanisms (xC1), [x=1,2,3, . . . ,11], which flow channel high-speed air molecules into the chambers or out(x=12) and mechanisms increasing the speed of water vapour, wherein according to the principle of BERNOULLI, that the product of the water vapor pressure times flow speed rate is constant, results in reducing the pressure exerted by the water vapour on the surface of non-potable water, while increasing the speed of the water vapour from the outlet of (Bx), which means the lowering of the water boiling temperature and the increase of the evaporation rate, wherein the mechanisms, channel air flow in the same direction as that of water vapour, towards (Yx), increasing their speed which results in lowering the boiling temperature and increase the water evaporation rate, wherein only one of the (xC1), x=1,5,6,9,12, may replace all others, having a flow speed equal to the sum of the flow speed of the others, wherein (xC1), x=2,7,8,10, channel flow of air molecules opposite to the direction of the water vapor, wherein the mechanisms (3C1), (4C1), (10C1) channel air flow into (Bx), increasing the escape speed through output (A), thereby lowering the boiling temperature and increasing the water vapour generation, a second chamber (By1aβ) into which water vapour is inserted to separate droplets from water vapor, (2C1), which facilitates(ease) the separation of droplets from vapour, the (11C1) inside (Y3), which injects air into the tubing (Fx), through (F5) externally of (Y3), vertically to the flow of vapour, contributing to the increase the liquefaction rate, layers (tablets) (LR1), (LR2), (LR3), (LR) outside and inside of the chamber (Gx, 15gx) with useful components as magnesium, potassium etc which are dissolved by vapour with water,to enrich water as it passes through the said layers, the mechanism (Lgx), which channels flow air molecules to layers (LRx), which air being enriched with useful components are pushed towards chamber (Gx 15gx), mechanism (15gx) in the chamber (Gx) to control maximum drinking water level threshold, single input direction control non-return valves (23g), (17gx), (16b), (18b), (23g), (23gk), (23zc), (23ze), (23eb), (23by), stainless membranes (102bx), (102by), a thermostat (117bx, 195), set to interrupt heating of the system at temperatures <100° C., wherein the switching temperature is defined by the value of the water vapour pressure within (Bx), and decreases as the speed of the air molecules channeled by (12C1)out of (Bx) or channeled into (Bx) by (3C1), (4C1), (10C1), (Lbx) increases, wherein during the interruption of water heating, which is automatically performed by (117bx, 195) at the lowest selected threshold level, the valve (16b) is commanded by a mechanism and control sensor (T,12) to fill (Bx) and simultaneously (Y3) of (Yx) is automatically set in operation, receiving command from the microprocessor (Ubx), from the control mechanisms (T,12) and (Qbx, 15bx), of the safe position limits level (11bx) connected with (117bx, 195) and valve (16b), for filling (Bx) with non-potable water, and the upper level should be at a certain safe distance from the exit of the water vapour (A), a mechanism (I), providing DC or AC to an electrical coil (I1), generating magnetic fields, also supplying two metal plates (I2), generating vertical electric field to the movement of vapor, thereby preventing the escape of certain ions, by the flow control mechanism (S) and level control mechanism (Qe, 15e) of the water for filling the tank (E) with water from the city network, or from solar panels, with hot non-drinking water for energy economy, or from various other intake sources, mechanism (210), with automatic non-return valve (23eb) and floater (210a), a kind of metal ball, or other container shape, with vacuum inside to fill the (Bx) from (E) up to the upper limit of (11bx), which shuts the flow of water by means of the stem (221) which contacts with the upper stem (234), thus, commanding for (Pe) supply to one of the (D), (Cbx), (Mx) for regulated heating and boiling of the non-potable water, whose (11bx) begins to drop due to the water vapour exit from (Bx), which simultaneously maintain stems (221) and (234) in contact due to pressure exerted on the (221), thus maintaining the electrical power supply, until the (11bx) reaches the lowest threshold, when (117bx, 195) commands the interruption of (Pe) supply and after ceasing boiling, and interruption of the pressure of water vapor on (221), an instruction is given by (117bx, 195), in cooperation with the timer (TC) and (T, 12), for the descent of (210a) along with (221), freeing the flow of water and the filling (Bx) from (E), until the upper limit of (11bx) in (Bx), wherein (11bx) meets (Qb, 15bx) which commands the (Pe) supply, for the boiling of the non-potable water whose (11bx) begins to lower due to the water vapour exit, and closing of the flow of water by means of (221) coming in contact with the bottom (234), a switch-mechanism (212α3) for interrupting or supplying (Pe) to one of the (D), (Cbx), (Mx), a mechanism (210b) with a single input automatic valve (221b), with a moving lever (258) and a return spring (228) of (221b), (258) as another version of mechanism (210), an electromagnetic valve (222a), comprising a coil (230) at the ends of which is applied A.C. or D.C. voltage, generating (producing) a magnetic field, an armature (reinforcement) (223) which is moved upwardly under the influence of the magnetic field and is controlled so that the flow of water is shut by means of (221), which comes in contact with the upper and lower stem (234), wherein (230) is part of a circuit which includes (117bx, 195), and one of the (D), (Cbx), (Mx) for regulated heating and boiling of the non-potable water, whose (11bx) begins to lower due to the exit of vapour, until it reaches the lowest threshold, when (117bx, 195) commands the interruption of (Pe) supply to one of the mechanisms (D), (Cbx), (Mx) and (230), resulting in the cessation of the influence of the magnetic field on (223) and (221), wherein after the (Pe) supply interruption, boiling ceases and pressure on (221) decreases, resulting in the descent of (223) together with (along with) (221) to an intermediate between the two positions of (234), releasing water flow and allowing the automatic filling of (Bx) from (E), until the upper limit, wherein (11bx) at (Bx) meets (T, 15bx) of which is commanded to close the flow of water by means of (221) and upper (234),and a command is also given for (Pe) supply to the electromagnetic valve (222a), to heat and boil the non-potable water whose (11bx) begins to drop due to the water vapour outlet, as the operation of the electromagnetic valve (222a), of the device and all settings are coordinated by the (Ub8), via the outlet pipe of the water vapour (EXY1) of the first chamber (Gx), water vapor that has not been liquefied is transferred, by the compression (O1a) and transmission (Z1a) mechanisms, and by a relief valve (208) towards (Yx), wherein also a part of the water vapour is transferred to (11C1), inside (Y3), where a significant part of the water vapour is condensed, with the produced water and the remaining water vapour being carried in chamber (Y4) with compressed air, and to compression chamber (Y5), where another part of the water vapour is also condensed, with the produced water and the remaining water vapour being carried in chamber (Gx), moreover through the vapour outlet pipe of a second chamber (Gx), the water vapor that has not been liquefied by the compression (O1b) and transmission (Z1b) mechanisms is transferred towards (4C1) and (Bx), or to (E),mechanism (Lbx) and (18b) for air inlet into (Bx), a pressure gauge (147) for measuring and regulating the pressure inside the chamber (Bx), which influences boiling temperature and evaporation rate, wherein the pressure is controlled by air outlet mechanism (12C1) which channel air flow outlet from chamber (Gx) which communicates with (Bx) through pipes of the system, and by air inlet mechanism (3C1), (4C1), (10C1), (Lbx) which channel air flow into (Bx), a drinking water outlet mechanism (Kgx, 25, 26), a brine outlet mechanism (Pbx) from (Bx) by means of the sensor (48bx) that detects the brine density, from the brine collection vessel (Rbx) through a valve (47bx), a thermometer (120), a timer (TC) and a microprocessor (Ubx) that coordinates the operation of the whole system and the door opening (9) in the chambers (Bx), wherein the system can be simplified by using manual valves to fill (Bx), and discharge (Gx), voiding the automatic mechanisms. FIG. 2 [1(b)] shows an overview of the device for the conversion of non-potable water into ecological drinking water, comprising: of (3C1b), through which water vapour transported from (Gx), through the pipe (EXY1),towards (Bx) and through the discharge valve (208) and (Z1a) towards (E); also in FIG. 1(b) part of the water vapor is transferred to a chamber (Yb) inside (Y3), an electromagnetic valve (222b), comprising of a coil (230) at the ends of which A.C. or D.C. voltage is applied, producing a magnetic field, of an armature (reinforcement) (229) which presses ring (231), by means of a spring (228),that is in contact with an elastic washer (grommet) (234), wherein (229) moves upwardly under the influence of the magnetic field so that it opens the water flow towards (Bx), while receiver (228) resets (229) to its original position when A.C. or D.C. voltage is not applied, of the sensor (240, 241α, 241β), that detects (11bx) in the water, at the upper limit of (Bx), which comprises of two metallic spikes (241α), (241β) with ceramic insulation, wherein typically one of the two spikes can be replaced by the stainless frame (shell) of (Bx), of an electromagnetic switch (242) as a relay, which comprises of a coil (243), an armature (246) as an electromagnet, of a metal plate (244) which moves either downwardly under the influence of the magnetic field (246), thus opening the circuit of the electromagnetic (222b), or upwardly, closing this circuit under the effect of the return spring (245), when the effect of the magnetic field of armature (246) ceases, a current amplifier (Am) to amplify the weak current flowing (runs) through the coil (243), due to the high electrical resistance of the water, a thermostat (117bx, 195), comprising of two levers (258a), (258b) and the rod (195), whose length is further increased, depending on the temperature of the non-drinking water, leading the end of (258α) upwardly, while the other end is driven downwards, causing the end (257α) to lose contact with the shaft (259α), thus interrupting the supply of (Pe) on one of the (D), (Cbx), (Mx), while the edge of (258β) is driven upwardly while the other end of (258B) is driven downwardly, causing the end of (257β) into contact with (259β) so that the flow of water is released towards (Bx), which lasts until the (11bx) of the water comes in contact with the (241α), (241β), closing the circuit (241α), (241β), (243), (Na), (Fa), (241α), which activates (246) the electromagnetic switch (242), pulling (244) and interrupting the circuit (230), (224β), (Na), (Fa), (258β), (257β), (259β), (244), (224α), (230), interrupring the (Pe) to (222b), which results in stopping the flow of water towards (Bx) with the aid of the (228) which pushes the cathode (229) with the (231) to reach into contact with the (234), closing the flow of water whose (11bx) begins to drop due to the output of the water vapor, the spring (251α) which pulls (259α) so that it reaches to be in contact with (257α), wherein above the limit of the boiling temperature it loses contact with (259α),so that to stop the (Pe), the spring (251β) which repels (259β), so that it loses contact with (257β), while above the limit of boiling temperature it contacts (259β), activating (222b), to open the flow of water towards (Bx), wherein (230) receives a command by the thermostat to interrupt (Pe), when the (11bx) reaches the lower threshold, while the (243) contributes to stop (Pe), when the (11bx) reaches the maximum contact limit with the (240, 241α, 241β), or the (15bx, Qb8), closing the flow of water to the (Bx), two circuits (230), (Na), (244), (230), and (Na), (Cbx), (259α), (Na), which separately receive commands from the thermostat for supplying or stopping (Pe), and when the first circuit is activated to fill the (Bx), the second circuit for boiling remains inactive, wherein during the interruption (Pe), controlled by the (TC) the filling of (Bx) is performed automatically from various sources hydrant (of water intake). while simultaneously (Y3) of (Yx) is automatically activated, which is also controlled by the (TC), while by the same thermostat a command is given to apply A.C, or D.C. voltage across the (230) releasing the flow of water to fill (Bx), up to the upper limit, wherein (11bx) meets (241α), (241β), or (15bx, Qb8), wherein a command is given to (242) to stop (Pe), towards (222b). FIG. 3 [1(c)] shows a simplified view of the device for the conversion of non-potable water into ecological drinking water, that comprises of: the rapid deep-freezing mechanism (Y3) with its inner space filled with ice packs (Ic) of high heat capacity, through which space passes the pipeline with water vapor (F3), several meters long and spacious with folds, grid-shaped, (streamers) on a horizontal surface or spiral-shaped (coil) with vertical axis,[both surrounded by ice packs (Ic)], so as to prevent the accumulation of water, where inside and outside of (F3) an electrically heated resistance (R) is mounted to avoid ice development and to prevent clogging of the piping by(of) ice, a fan (H) at a minimum distance from (F3) below or above, for faster condensation of the vapour falling, heat and transport of the hot air to the tank (E), which ice packs cover the inner walls of the device (Y3) for shielding against overheating of the refrigerant gas, the electric machine of the freezer and the clogging of piping, two thermostats (117bcα, 197α) and (117bcβ, 197β), the first (117bcα, 197α) with a lever (258α), and with the rod (195α), whose length (195α) is further increased, depending on the non-potable water temperature, above the limit boiling temperatureπoυ (117bcα, 197α), wherein (117bcα, 197α) is set to stop heating in temperatures <100° C., so that the temperature to stop (Pe) to (201) for boiling, is adjusted by means of the first (117bcα, 197α), wherein during the interruption of (Pe), at the same time the chamber (Bx) is filled with water from (E), by means of the second (117bcβ, 197β) and (222b), while (Y3) of (Yx) is automatically activated, receiving command from the microprocessor (Ub8), in cooperation with the (TC), where at the lower threshold (11bc) of (Bx), the water temperature exceeds the limit boiling temperature, which is set to cut off the heating of the system the first (117bcα, 197α), resulting in (257α) losing contact and thereby interrupt the supply of (Pe) to (201) for heating and boiling the non-potable water, while the edge (258β) of the second (117bcβ, 197β) moves upwardly, while the other end (258β) moves downwardly, so that (257β) comes into contact with (259β), activating (222b), resulting in opening the flow of water to (Bx), which flow lasts until (11bc) of the water reaches (241α), (241β), activating (246) of the electromagnetic switch (242), thereby interrupting the flow of water to the (Bx), wherein during the interruption of the supply of (Pe) to (201), the (Bx) is automatically filled from various other sources of water hydrant (intake), an amplifier (Am) to amplify the weak current that runs through the coil (243) due to the high electrical resistance of the water, the springs (251α), (251β), as described above with reference to FIG. 2 [1(b)] where the function and all device settings with reference to FIGS. 2 [1(b)], and 3 [1(c)] are coordinated by the microprocessor (Ub8) setting any preferred operating time for the mechanisms and valves.

According to the second embodiment of the invention, illustrated in FIG. 4 [2(a)], which shows a simplified view of the device for the conversion of non-potable water into ecological drinking water, comprising of: the chamber (B1β), whose removable side (3), for spacious access to the interior of the chamber (B1β), is mounted on a sheet of elastic material (6) and is fixed with screws, to the chamber (B1a), which is filled with non-potable water, for heating and rapid evaporation, by setting a limit boiling temperature <100° C., which is located inside the chamber (B1β), a metallic chamber (B1γ), which contains the airtight chamber (B1β), wherein (B1γ) is for shielding of the microwave radiation (46) generated by the magnetron of mechanism (D), and, emitted from the curved surfaces (10) of the chamber (B1β), a mechanism (9) for the opening of the chamber door (B1γ), with glass and metal screen for the visual inspection of chambers (B1α), (B1β) and microwave shielding, mechanisms (xC2), [x=1,2,3,4], which channel high-speed flow of air molecules into the chambers and the piping system, increasing the vapor escape speed from outlet (4) of chamber (B1α), towards a network of stainless piping, vapor condensation mechanisms and drinking water collection chambers, thereby reducing the pressure of water vapor on the boiling surface, as the boiling temperature is proportional of the pressure exerted by the water vapor on the surface of non-potable water, wherein mechanism (1C2) channels flow of air molecules to the same direction as the movement of water vapor, and mechanism (2C2) channels flow air molecules inside chamber (By), contrary to the direction of movement of water vapor, in which chamber (By), water vapor is discharged of the droplets of non-potable water, and the droplets return to the boiling chamber via tubing or through the device (26), where mechanism (3C2) channels flow of air molecules within chamber (B1α), resulting in the increase of the escape velocity of the water vapor from the outlet (4) of chamber (B1α), with consequent reduction of the pressure of water vapor on the boiling surface of chamber (B1α) wherein mechanism (4C2) injects air molecules flow into the chamber (B1α) with the remainder of the water vapor, which has not been liquefied in the relevant mechanisms, through the automatic valve of an inlet (23zc), the thermal energy mechanism (D) for microwave generation and emission (46) into the chambers (B1α), (B1β) (B1γ) for rapid and economical increase of the temperature of non-potable water in the chamber (B1α), through dielectric heating for uniform stimulation (excitation) of polarized molecules due to the rapid microwave polarity change, which causes rapid rotation of the water molecules, automatic single direction vapor discharge valves (208), single input valves, similar to those of FIG. 1(a), a thermostat (117b1α) within the chamber (B1a) set to interrupt the heating of the system at temperatures lower than 100° C., as the temperature of heating and boiling the non potable water, which is interrupting the power supply to the thermal energy device (D), it is proportional to the value of the water vapor pressure within the chamber (B1α) and decreases with increasing inflow velocity of air molecules pumped by the mechanisms (3C2), (4C2), (Lb1) within the chamber (B1α) which are mixed with water and air molecules pumped by the mechanisms (12C2) outside the chamber (G1β), so that the interruption of the power supply to the thermal energy device (D), is adjusted to a temperature which ensures a satisfactory operating time for the economical heating of non-potable water and adequate rapid evaporation, while during the power supply interruption, chamber (B1α) is automatically filled from the reservoir (E) through tube (14), valve (16b1α) and level control mechanism (T), (Qb1α), with the sensors (12), (15b1α) for not breaching the limit level (11b), and the refrigeration mechanism (Y3) of (Yx) is automatically activated, receiving a command from the microprocessor (Ub1), like all other functions, where the upper level of non-potable water in the chamber (B1α) must be at a certain safe distance from the water vapor outlets. FIG. 4 [2(b)] shows a simplified view of the device for the conversion of non-potable water into ecological drinking water, comprising of: chamber (B1β) with two outlets (4α) and (4β) for the escape of larger amount of water vapor compared to that of the one outlet of chamber (B1β) in FIG. 4 [2(a)].

According to the third preferred integrated embodiment of the invention, illustrated in FIG. 5 [3(a)], as a simplified view of the device for the conversion of non-potable water into ecological drinking water, is characterized in that it comprises of: an outer casing made of insulating material (B8βb) and an inner metal chamber (B8αb) for the boiling of the non-potable water, with a removable side (3b8αb), which is mounted onto an elastic sheet (6b8), for spacious access to the chamber, a chamber (Bya) into which water vapor is pumped via stainless steel pipe, or high hardness multinetwork polyethylene piping, to separate the droplets of non-potable water, condensing devices (Y3), (Jx), (Ix), (Yx) x=1,2,3,4 5 with the effects of cold fluid stream and compression, wherein (Y1) comprises a stainless pipe with cold fluid stream, and through (Y1) tubing, (F1) coaxially passes with vapor, (Y2) includes a cold fluid reservoir through which (F2) passes filled with water vapor, (Y3) includes a rapid-deep freezing gas of the electric motor of the freezer against overheating, where through (Y3) passes (F3), which is a grid shape (coil) device, several-meters long, spacious with folds and filled with vapor, placed either on an horizontal or vertical surface, or in the form (shape) of cyclic coi (thread) with vertical axis,so as to avoid the accumulation of water, wherein inside and outside (F3) an electrically heated ohmic resistor (R) is installed to avoid (prevent) water accumulation and clogging of piping by ice, fan (H) mounted at a minimum distance above or below (F3) to accelerate condensation of water vapor, which transfers heat and whisks hot air to the tank (E), as the operation of the freezer is interrupted by a thermostat in case of overheating, wherein the inlet and the outlet of (F3) in (Y3) is more efficient when placed on the upper or lower side of the refrigerator, the arrangement on the other hand is simplified by the use of valves for manually filling (Bx) and emptying (Gx), skipping the double switch automatic mechanisms, from chamber (Y4) filled with compressed air, and compression mechanism (Y5), both through which pass pipes (F4), (Fx) with water vapor, from the air freezing mechanisms (Jx) via fans (Ix) to the piping (F3), from the layers (LR3), (LR) outside and inside the chamber (Gx) with beneficial components absorbed by the water as it passes through the said layers, such as magnesium, potassium and others, from mechanism (LG3), which channels high velocity air molecules flow into the chamber containing layer (LR3) and incoming vapors with water from the pipe (Fx), enriched with beneficial components, which are pushed towards the chamber (Gx), a resistor (201) connected to the contacts (F, 158) and (N, 159) via conductors (199) to provide (Pe), wherein closing the circuit of the system, Vac is applied on (201), causing heating of the water by induction, inside (B8αb), according to the law of Ohm, a magnesium rod (124b8), and a porcelain layer (206), to protect the interior of (B8αb), the mechanisms (xC3a), x=1,3,4,5,6, which channel high velocity air molecules flow into the said (B8αb), (Bya) and (Y3), (Jx), (Ix), (Yx) x=1,2,3,4,5, increasing the escape speed of water vapor from (B8αb), thus causing a reduction in the pressure of water vapor and the boiling temperature below 100° C., the reservoir (E), through mechanism (210A) for filling (B8ab), wherein the mechanisms (2C3a) and (6C3a) channel flow of air molecules to the (Bya) and mechanisms (1C3a), (5C3a) towards mechanisms (Yx), increasing the speed of water vapor, and thereby causing boiling temperature to drop below 100° C. and rapid production of water vapor, which are transferred to the (Byz) where water droplets are separated from vapor, as the bottom part of the vapor transport tube into the (Byz) is perforated and the blocked bottom of the tube is perforated, wherein part of the water vapor from chamber (Gx), which has not been liquefied, is transferred to chamber (B8αb), by means of mechanism (4C3a), while the remaining part is transferred by means of transport mechanism (Z1a), either to mechanisms (Yx), through a compression chamber (Y5) or to tank (E), by mechanism (210α) with floater (210α), wherein the supply of water is interrupted by the water passage valve (16c), pressed to close by the arm (bracket) (210c), when the level (11b8) reaches the upper limit, while electrical power is supplied, due to the contact of stem (member) (212a1) with the stem (212b), with subsequent boiling of potable water and rapid production of water vapor, which is transferred to chamber (Bya), resulting in cathode (drop) of (11b8) of the water and the floater (210a), causing opening the valve (16c), while valve (23eb) regulates the appropriate amount of water to be inserted into the (B8αb), so that (11b8) remains constant at a preselected position during operation of the device, by switch-mechanism (212a3) to interrupt or provide electrical power to (201), wherein (221) which is fixedly connected to the arm (210c), moves upwards following the rise of the floater (210a), with the rise of (11b8) of the water, because of the flow of the non-potable water inside (B8αb) from the reservoir (E), by mechanism (210A), and thereby the said member (221) comes in contact with (212a3) at the upper level of (11b8), and closes the circuit (221), (212a3), (N, 159), (F, 158), (201), (117b8, 195), (257α) (259α), (221), causing Vac application onto (201), while stem (221), upper member (234) and (212a3) facilitate the closure of the flow of water, wherein the application of Vac onto (201) has as a consequence the production of water vapor, which are transferred to chamber (Bya), causing cathode (drop) of (11b8), wherein at the lowest level the thermostat signals the interruption of the electrical power, as the water temperature exceeds the temperature the thermostat is set to cut off heating, resulting in (257α) losing contact with (259α), thereby interrupting the circuit (257α), (N, 159), (201), (258α), and cutting off power to (201), which stops boiling and reduces the pressure applied onto (221), so that the water flow pressure downwardly prevails over the reduced upward vapor pressure, for the automatic filling of chamber (B8αb),a mechanism (210B) alike (210b) with reference to FIG. 1(a),a device (EXY1), where non-condensate vapor are transferred from (B8αb) and through (Z1a), to a chamber (Ya),in which all device settings are coordinated by the microprocessor (Ub8), and all other parts of FIG. 5 [3(a)], can be described with reference to FIG. 1 [1(a)]. FIG. 6 [3(b)] shows another view of the device for the conversion of non-potable water into ecological drinking water which is characterized in that it comprises of: valve (222a), as described with reference to FIG. 1 [1(b)], wherein armor (229) and stem (231), converted to a magnet move upwards, as they attract the fixedly mounted perforated component (227), leaving free passage for the flow of water to chamber (B8αb), while spring (228) restores (229) to its original position, when AC or D.C voltage is not applied, from the sensor (240,241a, 241b), that detects level (11b8) of water, and electromagnetic switch (242), as described with reference to FIG. 1(b), wherein under the effect of the armor's magnetic field (246) the circuit of the electromagnetic valve (222a) opens, or closes under the effect of spring (245), [A tubular electropump can replace (222a), when the feed of water (B8αb) is incapable] a thermostat (117bx 197b), that interrupts below 100°, where (B8αb) is filled, and refrigerator (Yx) is set to operation, taking command from (Ub8), alike all other processes, wherein the length of rod (195b) increases with increasing water temperature above the limit temperature, moving the tip of lever (258α) to the left, interrupting (Pe) onto (201), while edge (258β) is also driven to the left, so (257β) come into contact with (259β), to open the flow of water towards (B8αb), which lasts until the water level (11b8) reaches pins (241a), (241β) with consequent interruption of the water flow by means of the spring (228), whose level (11b8) starts to drop due to the water vapor outlet, a current amplifier (Am) to strengthen the weak current flowing running through coil (243), due to the high electrical resistance of the water, tube (EXY1) where non condensate vapor is transferred through (O1ab), (Z1ab), (3C3b) to the chamber (B8αb) and chamber (Yb) in refrigerator (Y3). FIG. 7 [3(c)] shows a view of the device for the conversion of non-potable water into ecological drinking water,which is characterized in that it comprises of: electromagnetic valve (222b), coil (230), armor (229) which presses ring (231) with the spring (228) to remain in contact with an elastic ring (234), wherein (229) moves upwardly by the effect of the magnetic field, resulting in water flow to chamber (B8αb), while (228) resets (229) to its original position when A.C. or D.C. voltage is not applied, from the sensor (240,241α, 241β) that detects the level (11b8) of water, wherein sensor (241α) is an electrode positioned at desired height in the boiling chamber (B8αb) with a conductive wall.(shell) and connected to grounding, and if electrode (241α) is under voltage, there will be a current flow from the electrode to the wall (shell) as well as to the grounding through water and as this current is weak to be detected, due to the high electrical resistance of the water, the sensor is connected to a current amplifier (Am) to strengthen the weak current which runs through the coil (243), at the input of a transistor Q1 NPN which operates as a switch, and in order not to damage the circuit microcontroller from voltages which may occur on the electrode, there is an optical isolator (opto-isolator), electromagnetic switch (242) as a relay, two thermostats, the first (117b8α 197α), which is set to cut off the power below 100° C., wherein the boiling temperature is decreased as the air molecules influx velocity is increased by mechanisms (3C3c), (Lbx), and the second (117bcβ197β), and electromagnetic valve (222b), chamber (B8αb) is filled with water and simultaneously (Y3) is put in freezing mode, as commanded by (Ub8), which lasts until (11b8) comes into contact with the pins (241α), (241β), resulting in the interruption of power supply to the electromagnetic valve (222b), with consequent interruption of the water flow to (B8αb), whose (11b8) starts to fall due to the water vapor outlet, to the lower limit of (B8αb) which stops (Pe) onto (201) by the thermostat (117b8α 197α) of the circuit (F, 158), (201), (195α), (258α), (257α), (259α), (N, 159), because of the water temperature rise over the marginal boiling temperature, exceeding the target temperature of interruption, within which the (117b8α 197α) is set to operate, and during the discontinuance of power supply to (201), which is controlled by the (TC), at the same time freezing mechanism (Y3) is automatically set to operation, which is also controlled by the (TC), and at the same time (B8αb) is filled with non-potable water, up to the point when (11b8) meets one of the sensors (240, 241α, 241β) or (15b8) which will signal the interruption of power supply to the electromagnetic valve (222b), interrupting the flow of water to (B8αb), and as the length of the rod (195α) increases at the lower limit of (B8αb), as described with reference to 1(b), 3(b), the tip of the lever (258α) of the first thermostat (117b8α, 197α), is displaced to the left, thus interrupting the power to the resistor (201), and simultaneously the (258β) of the second thermostat (117bcβ 197β) is also shifted to the left, thereby opening the flow of water to (B8αb), rapid deep freezing mechanism (Y3) with its inner space filled with ice packs (Ic) of high heat capacity, which cover the inner walls of the device (Y3) for shielding the refrigerant gas, the electric motor freezer and clogging of pipe in against overheating and preventing tube clogging, where through space (Y3) passes (F3), filled with steam and several meters long and spacious with folds, grid shape (coil) on a horizontal surface, so as to prevent the accumulation of water, where inside and outside (F3) electrically heated resistor (R) is installed to prevent clogging of the piping by ice, fan (H) placed at a minimum distance above or below (F3), to accelerate condensation of water vapor, which transfers, heat and whisks hot air to the tank (E), as the operation of the freezer is interrupted by a thermostat in case of overheating, wherein the entrance of (F3) in the interior of (Y3) and the outlet from the inside can achieved from the upper or the lower side of the freezer, where the system is simplified by using valves to fill (Bx) manually, and empty (Gx), bypassing the double switch automatic mechanisms. FIG. 7 [3(d)] depicts a complete water level (11bc), control system at the boiling chamber (B8αb) of the device for the conversion of non-potable water into ecological drinking water, which according to the third preferred integrated embodiment of the present invention, is characterized in that it comprises of:

four optical isolators (opto-isolators), three position sensors s1, s2, s3, for the water level (11bc), sensor at position s1 to control whether the heating resistance (201) is covered with water and if not, the heating of (201) should be discontinued with relay 2, a sensor at position s2 which marks the lower filling threshold level (11bc), a sensor at position s3 (241α) that marks the upper filling threshold level (11bc), the microcontroller MCU that is programmed to operate according to the input control for the activation of the relay 1 (Relay1) and the electromagnetic filler valve (222b), wherein relay 1 controls the electromagnetic valve (222b) while relay 2 controls the heating resistor, allowing its operation when the s1 sensor is covered by the water, whilst the absence of water interrupts its operation to protect the resistor (201), where only for one input of s1 will the microcontroller MCU activate the electromagnetic valve (222b) and when the chamber is filled with water, it will induce a time delay, and reopen the valve for new filling, wherein to apply only two inputs s1 and s2 which are the lower and upper limit of the water level, a second relay for the heating resistor (201) is not necessary, so depending on which inputs are active and what their situation was previously, the programme of the microcontroller MCU decides whether to open or close the filler valve via the relay, as each level (11bc) position of sensor input sx, is an electrode (241α) mounted at a desired height in the boiling chamber (B8αb) with a conductive shell and it is grounding, and if the electrode (241α) is under voltage, there will be a current flow from the electrode to the shell as well as to the grounding through water and as this current is weak to be detected, the sensor is connected to the input of a transistor Q1 NPN which operates as a switch, and in order not to damage the microcontroller from voltages which may occur on the electrode, there is an optical isolator (opto-isolator). FIG. 7 [3(e)] shows a simple circuit opened by a valve when water reaches the sensor, which circuit comprises of: time relay L1, a relay REL1, a transistor Q1 NPN and resistors R1, R2, wherein the delay in restarting the valve can be determined by the time relay in position L1, while the valve is connected to the time relay via a power supply.

According to the fourth embodiment of the invention, illustrated in FIG. 8 [4(a)], the device for the conversion of non-potable water into ecological drinking water, is characterized in that it comprises of: a chamber (B1γ), within which a chamber (B1β) is placed and inside (B1β) there is a third chamber (B1α) filled with non-potable water, a water vapor outlet (4), a mechanism (M3), as a heating source, by applying Vac (Vac, 143) of various wave forms and frequencies, onto two electrodes (148) inside the chamber (B1α) walls and onto two electrodes (149) outside the chamber for heating chamber (B1α) at temperatures below 100° C., which is achieved by the vibration of ions, and said temperature is maintained constant by means of the thermostat (117bα) and the pressure gauge (147) outside water, corresponding to water boiling temperature <100° C. and pressure regulation upon which the boiling temperature depends and is controlled by mechanisms (3C4), (Lb1α) and the valve (23) that channel flow of air molecules inside chamber (B1α), increasing the rate of escape of water from the outlet (4) and reducing their pressure, since at pressure of 700 mbar, the boiling temperature is 90° C., from chamber (By) for separating the droplets of the non-potable water from water vapor, from mechanism (W) for adjusting the power (145) and the operating time (144) of the system. According to the fourth integrated embodiment of the invention, illustrated in FIG. 8 [4(b)], the system is characterized by curve (140b) of FIG. 8 4(b), wherein the water boiling point is graphically depicted by curve (140β), in proportional scale, as a function of the boiling temperature of water in degrees Celsius and the applied pressure in mbar on the water surface.

According to the fifth embodiment of the invention, illustrated in FIG. 9 5 {5(a).5(b),5(c),5(d)}, the device for the conversion of non-potable water into ecological drinking water is characterized in that comprises of: a frusto-conical chamber (G2), with a rubber cap (76a), which blocks the orifice (G2a), a tube (20g2) to inject vapor (78), and water (27g2) to (G2) and in the form water vapor (77) in tube (21g2), to transport to mechanisms (O1a), (Z1a), (Bz), (Yx), either to mechanism (4C5), which injects air molecules flow into the boiling chamber (B1α) with the remainder of water vapor, or to tank (E), from mechanism (15gam) for controlling the threshold level in (G2), from a chamber (G3) in FIG. 5(b), with a frusto-conical plug (76b), chamber (G4), in FIG. 5(c), with side walls as cylindrical surfaces and frusto-conical cap (76c), a chamber (G5) in FIG. 5(d), with cylindrical surfaces as side walls and a metal cap (50) placed on a sheet of elastic material (6), wherein increasing the number of steam outlet channel also increases the amount of drinking water, collected at (G1α) and (G1β, along with other types of chambers (G2), (G3), (G4), (G5), which could replace (G1α) and (G1β) of the former versions of this invention.

According to the sixth embodiment of the invention, illustrated in FIG. 10 [6(a)], the device for the conversion of non-potable water into ecological drinking water, is characterized in that comprises of: chamber (B2α) with the cylindrical surface (83α) and simple funnel-shaped surface (83β), with an, output (4b2a), wherein surface (83β) is positioned with its base (82) on an elastic material sheet (6), fixed by screws on base (81) of the lower surface (83α), from chamber (By), from mechanism (1C6), which injects air molecules flow into chamber (By) thereby lowering the boiling temperature, from mechanism (2C6) that injects air molecules flow to the opposite the direction of the movement of the water vapor within chamber (By), from mechanism (3C6) that injects feed air molecules into chamber (B2α) thus reducing the boiling temperature, from vapor condensing mechanisms (Bz), (Yx), and collecting drinking water at (Gx), from compression mechanism (O1a) and mechanism (Z1a) to transport the remaining water vapor to (Bz), (Yx), (3C2a), (B2α), (E), heat production. mechanism (Cb2a), a thermostat (117b2α) inside chamber (B2a), mechanism adjusting the length of operation and power supply (7b2α), a microprocessor (Ub1), which coordinates the operation of the whole system. According to the sixth embodiment of the invention, illustrated in FIG. 10 [6(b)], the device for the conversion of non-potable water into ecological drinking water, alternatively for an even larger increase in the quantity of water vapor is characterized in that comprises of: chamber (B2β) with the lower cylindrical surface (109αi) and upper double-funnel-shaped surface (109αii), with two outputs (4b2αi), (4b2αii) for the escape of even larger quantity of water vapor, with the upper surface (109αii) placed on an elastic sheet material (6) and fixed by screws (93) on the base (99) of the bottom surface (109αi), from mechanism (12C6), which absorbs with high-speed air flow channel molecules aout from chamber (B2β) thereby lowering the boiling temperature, from heat production mechanism (Cb2β) with a thermostat (117b2α2) which is in contact with the external bottom surface of the chamber (B2β) heating the non-potable water externaly by heating the external bottom surface of the chamber (B2(3).

According to the seventh embodiment of the invention, illustrated in FIG. 1l [7(a)], the device for the conversion of non-potable water into ecological drinking water, is characterized in that comprises of: an outer chamber (B7β) and an inner chamber (B7αa) with common bottom (178b7α) made of transparent glass that allows infrared radiation of wavelength of 2.8 μm to reach into the water, heat production mechanism (M6a), consisting of a heater outside bottom (178b7a) with a quartz tube (183) filled with inert gas (186), the buckles (181α), (181β) of a refractory metal which connect the coil terminals (180) to the phase (F, 158) and the grounding (N, 159), quartz rod (187) to transmit radiation from 1.3 μm to 3.1 μm, with a maximum water absorption value at 2.8 μm, wherein the infrared radiation is absorbed by the glass bulb, stimulating the silicon-oxygen bonds which then emit the above mentioned radiation, reflector (189) to double the radiation and accelerate heating, from mechanisms (3C7), (Lb7), (1C7), (4C7) with a flow of air molecules inside chambers (B7αa), (By), and from mechanism, (12C7), with a flow of air molecules aoutside chambers (B7αa), (By), resulting in reduced pressure and boiling temperature, less than 100° C., mechanism (2C7) with flow of air molecules opposite to the movement of water vapor to separate the droplets. FIG. 11 [7(b)], includes a heater, the same as described with reference to FIG. 11 [7(a)], inside chamber (B7αb) without reflector (189) as all internal chambers. FIG. 11 [7(c)], adds a heater with a carbon rod (190), for high quality heating at 1000° C. and response within seconds (1.3 μm-3.1 μm). FIG. 11 [7(d)], involves an internal heater, the same with reference to 7(c). FIG. 11 [7(e)], features an external heater with carbon coil (191) (thread), which is heated much faster than Fe, Cr and Al alloy at around 1000° C. FIG. 11 [7(f)], includes an internal heater, same with reference to FIG. 11 [7(e)], FIG. 1l [7(g)], contains ceramic rod (192) which is heated by the coil (180) from 300° C. to 700° C. FIG. 11 [7(h)], includes a heater itself with reference to FIG. 11 [7(g)], FIG. 11 [7(i)] comprises an outer heater with a tube the walls of which are of a refractory resistant (fireproof) ceramic (193) and the coil (180) of tungsten wire (thread) in spring form, for larger area (surface), or (FeCrAl) alloy which is inside the tube and closely adjacent to the ceramic walls (193) and heats said ceramic walls from 300° C. to 700° C. FIG. 11 [7(j)], includes an internal heater, the same with reference to FIG. 11 [7(i)].

According to the eighth integrated embodiment of the invention, illustrated in FIG. 12 [8(a)], the device for the conversion of non-potable water into ecological drinking water, is characterized in that comprises of: an inner (B3α) and an outer (B3β) chamber, a heating mechanism (M1) by means of application of an alternating magnetic field (amf) on the cavity (125) of the tubular ceramic (122), wherein the (a.m.f.), is produced by the coil (121) surrounding the tubular (122) and whose two ends are connected to the phase (F, 158) and the grounding (N, 159), wherein upon shutting the circuit (127b3) with the timer (7b3), Vac (126b3) is applied, setting the ions of the water in alternating rotary motion (a.r.m.) around the magnetic lines (m.1.) of (a.m.f.), causing rapid and economical growth of non-potable water temperature (13b3), wherein mechanism (3C8) injects air molecules flow into the boiling chamber (B3α), thus increasing the escape velocity of the water vapor from the outlet (4b3) under reduced pressure onto the boiling surface (11b3) and in accordance with the principle of D. BERNOULLI results in lowering the boiling temperature, mechanism (4C8) which channels air molecules flow with the remainder of the water vapor inside chamber (B3α) through the valve (23zc) with mechanisms (3C8), (Lb1a) and the valve (23b3), which mechanisms channel flow of air molecules inside chamber (B3α), increasing the escape speed of the water vapor from the outlet (4b3), and reducing the pressure on the boiling surface (11b3), which results in lowering the boiling temperature, that channels flow of air molecules to the chamber (By) in the same direction as the movement of water vapor, mechanism (2C8) which channels air molecules flow opposite to the direction of the movement of the water vapor within the chamber (By), freezing mechanism (Y3) (deep freezer), tank (E), digital control devices (Qb3), (Tb3) and sensors (15b3), (12b3), a thermostat (117b3) in chamber (B3α), and a microprocessor (Ub3) or microcontroler, wherein alternatively FIG. 12 [8(b)] depicts a simple coil (133) without the tubular ceramic (122), FIG. 12 [8(c)] shows a conventional resistor (134) and FIG. 12 [8(d)] shows another form of ohmic resistance (135).

According to the ninth integrated embodiment of the invention, as illustrated in FIG. 13 [9(a)], the device for the conversion of non-potable water into ecological drinking water, is characterized in that comprises of: an inner (B4α) and an outer (B4β) chamber, mechanism (M2) supplying electrical power to a halogen lamp heater with tungsten thread, positioned in the interior (143) of a closed quartz tube (142) filled with an inert low pressure gas and with minimal amount of iodine or bromine, where in the thread filament (141) and quartz (142) incandescence temperature, electromagnetic radiation at 1.0 μm to 3.1 μm is emitted, to heat the potable water at a temperature lower than 100° C., since the energy absorption spectrum of the water indicates its maximum value at 2.8 μm, two conductors (136), ending in cylindrical metal terminals (139), connected to the phase (F, 158) and the grounding (N, 159), of two parabolic metal mounting frames (140) connected to the ohmic resistor (141) and terminals (139), wherein by closing the circuit (127b4) with the timer [7b4 (TC)], Vac (126b4) is applied between the phase (F, 158) and the grounding (N, 159), resulting in the incandescence of the thread (141) and quartz halogen lamp (142) and so light and infrared electromagnetic radiation is emitted, wherein 97% of this energy is absorbed by the glass bulb made of flint quartz (silica), to excite (stimulate) the silicon-oxygen bonds of the quartz so that infrared and light radiation is emitted, as water and glass, being colorless bodies, are permeable to electromagnetic short-wave radiation, while water's high electromagnetic long wave radiation absorption rate (wavelength greater than 2 μm), result in rapid increase of the water temperature and the rapid production of water vapor, from mechanism (I), from chamber (By), from mechanism (1C9) that channels air molecules flow into chamber (By) in the same direction as the movement of water vapor, from mechanism (2C9) which channels air molecules flow in the opposite direction to the movement of the water vapor within chamber (By), from chamber (Bz), from cooling mechanism (Jx) via the fans (Hx) to the inlet of chamber (Bz), wherein the produced water flows into the drinking water collection chambers (Gx) through the other systems and water vapor condensation or compression mechanisms, mechanism (3C9) which channels air molecules flow into chamber (B4α), thereby reducing the pressure of water vapor on the boiling surface (11b4), mechanism (4C9), which channels air molecules flow with the remainder vapor within chamber (B4α), from mechanism (Lb4) channeling flow of air molecules inside chamber (B4α), from mechanism (12C9) which channels air molecules flow aoutside of the said chamber (Gx),and the said chamber (B4α), thereby reducing the pressure of water vapor and the boiling water temperature on the surface (11b4), the mechanism (12C9) can substitude all the mechanisms (xC9) which channel air molecules flow into the system, from compression mechanism (O1a), from mechanism (Z1a) that transfers the remaining water vapor, from tank (E), from digital control mechanisms (Qb4) and (Tb4) and sensors (15b4) and (12b4), from a thermostat (117b4) inside chamber (B4α), a microprocessor or microcontroler (Ub4). FIG. 13 [9(b)] shows another aspect of the halogen lamp of FIG. 13 [9(a)], rotated around axis (136) by 90° degrees.

According to the tenth integrated embodiment of the invention, illustrated in FIG. 14 [10(a)], the device for the conversion of non-potable water into ecological drinking water, is characterized in that comprises of: an outer (B5β) and an inner chamber (B5α) with metal bottom (166) inductively heated by current passing through a resistor (162), cyclically covering the periphery of the bottom, from mechanism (M4a) providing electrical power, with cyclically [(F, 158), (N, 159)], to the terminals (F, 158γ), and (N, 159γ) of the ohmic resistance (162) via contacts (F,158α), (F,158β) and (N,159α), (N,159β) with support bases (156α), (156αi), (156β), (156βi) and relay (165), wherein closing the circuit (127b5) with the timer [7b5 (TC)], Vac (126b5) is applied, thereby heating the electrical resistance (162) and by induction heating the metal plate (166) and the non-potable water in chamber (B5a) with heating rate being proportionate (according) with the intensity of the current flowing through the resistor (162) and the amount of water in the chamber (B5α), with consequent rapid boiling of the non-potable water in chamber (B5α), at a temperature lower than 100° C,where the value of this temperature depends on the value of the pressure of water vapor in chamber (B5α), resulting in the rapid production of water vapor, which is transported from the outlet (4b5), through chamber (By), towards the vapor condensation mechanisms (Bz), (Yx), wherein mechanism (1C10) channels flow of air molecules inside chamber (By), in the same direction with the movement of water vapor, increasing the speed of the water vapor, thereby reducing the pressure exerted by vapor on the surface of non-potable water in chamber (B5α) and thus lowering the boiling temperature and increasing water evaporation rate, while mechanism (2C10) injects air molecules flow opposite to the direction of vapor movement inside chamber (By), which helps to separate the water vapor from the droplets of the non-drinking water, from chamber (Bz) through which the network of water vapor transport pipe passes, wherein the interior of the chamber is cooled by cold fluid stream produced by cooling mechanisms (Jx) and channeled through the fan (Hx) to the inlet of chamber (Bz), for the liquefaction of a part of water vapor by cooling, as the produced water flows into the drinking water collection chambers (Gx) through the remaining vapor condensation mechanisms (Yx), where vapors are condensed by rapid cooling freezer under the effect of cold fluid stream and/or compression and the produced water flows in chambers (Gx), mechanism (3C10), which channels flow of air molecules inside chamber (B5α), thereby reducing the pressure of water vapor on the boiling surface (10b5), from mechanism (4C10) which channels air molecules flow into chamber (B5α) with the remainder of water vapor, which has not been liquefied by the relevant mechanisms, mechanism (Lb5) which channels air molecules flow into the chamber (B5α),), from mechanism (12C10a) which channels air molecules flow aoutside of the said chamber (Gx),and the said chamber (B5α), thereby reducing the pressure of water vapor and the boiling water temperature on the surface (10b5), the mechanism (12C10a) can substitude all the mechanisms (xC10) which channel air molecules low into the system, from a thermostat (117b5) insidechamber (B5a), from a microprocessor or a microcondroler (Ub5), which coordinates the operation of the whole system.According to the tenth integrated embodiment of the invention illustrated in FIG. 14 [10(b)], the device for the conversion of non-potable water into ecological drinking water is characterized in that it differs from FIG. 14[10(a)] with regard to the arrangement of contacts (F,158α), (F,158β) and (N, 159α), (N, 159β) with support bases (156α), (156αi), (156β), (156βi) of mechanism (M4α) with the corresponding contacts (F, 158δ), (F, 158ε), and (N,159δ), (N,159ε) and mounting bases of these contacts (156δ) (156δi) (156ε) (156εi), referred (listed) in FIG. 14[10(b)] of the mechanism (M4b), alternatively chambers (B5a) and (Byz) can be replaced by cookers pressure, wherein the stainless tubes transfering steam and water, and all the mechanisms such as sensors for the water level control, temperature, pressure, valves and other devices are placed on the cylindrical vertical surface, and the heating mechanism with thermostat is placed externally in contact with the lower surface of the cookers pressure, while the top (lid) free from parts openes and closes by a lever with a spring.

According to the tenth integrated embodiment of the invention, illustrated in FIG. 15[10(c)], the device for the conversion of non-potable water into ecological drinking water is characterized in that it comprises of: an outer (B6β) and an inner chamber (B6α), wherein on the bottom and on insulated bases (172a), (172β) two conductive electrodes (173α), (173β) made of carbon or corrosion resistant alloy are mounted, which electrodes are connected to phase (F, 158) andgrounding (N, 159) by means of electric contact connectors (169α), (169β) of the wire conductors (171α), (171β) with insulation (170α), (170β) and the timer [7b6 (TC], wherein by closing the circuit (127b6α) with[7b6 (TC)], Vac is applied between the two electrodes (173α), (173β), setting the ions within the chamber (B6α) in vibration, with subsequent boiling of non-potable water in chamber (B6α) at a temperature <100° C., which depends on the value of the pressure of water vapor in chamber (B6α), resulting in the rapid production of water vapor, which are directed to the vapor condensation mechanisms (Bz), (Yx) wherein mechanism (1C11) injects air molecules flow into chamber (By) in the same direction as the movement of water vapor, increasing the speed of the water vapor and thus reducing the pressure exerted by the water vapor on the surface of non-potable water in chamber (B6α) and thus lowering the boiling temperature and increase the water evaporation rate, while mechanism (2C11) channels flow of air molecules opposite to the direction of vapor movement in chamber (By), which helps to separate the water vapor from the droplets of the non-drinking water, from chamber (Bz) through which the network of water vapor transport pipe passes through, wherein the interior of chamber (Bz) is cooled by cold fluid stream produced by cooling mechanisms (Jx) and channeled by the fan (Hx) to the inlet of chamber (Bz),for liquefaction of a part of water vapor by cooling, while the produced water flows into the drinking water collection chambers (Gx), from mechanism (3C11) which channels flow of air molecules into chamber (B6a), wherein non-potable water boils, resulting in increasing the water vapor escape rate from the outlet (4b6α) of chamber (B6α), thereby reducing the pressure of water vapor on the boiling surface (10b6),frommechanism (4C11) which channels air molecules flow into chamber (B6α) with the remainder of water vapor, which has not been liquefied by the relevant mechanisms, through single-direction valve (23zc), from mechanism (12C10c) which channels air molecules flow aoutside of the said chamber (Gx),and the said chamber (B6α), thereby reducing the pressure of water vapor and the boiling water temperature on the surface (10b6), the mechanism (12C10c) can substitude all the mechanisms (xC10) which channel air molecules flow into the system, from the tank (E), from digital control mechanisms (Qb6) and (Tb6) and sensors (15b6) and (12b6), from thermostat (117b6) in chamber (B6α) which has been set to operate the system at a temperature <100° C., which is proportional to the value of the vapor pressure, which is reduced as the inflow speed of the air molecules increases, channeled by mechanisms (4C10c), (3C10c), (Lb6), into chamber (B6α) and mixed with the water, or aoutflow by mechanism (12C10c), causing the switching temperature of the system operation by the thermostat (117b6) to be set at 80° C., or at even lower or higher values, thus improving the qualityand quantity of water produced, from a microprocessor (Ub6α) or a microcondroler which coordinates the operation of the whole system

According to the tenth integrated embodiment of the invention, illustrated in FIG. 15[10(d)],the device for the conversion of non-potable water into ecological drinking water is characterized in that it comprises of: an outer (B6β) and an inner (B6α) chamber, attached as a conductive electrode to the grounding (N,159), via cable (175β) with insulation (170β), where on the bottom or near the bottom of the said chamber (B6α)and on insulated base (172α)the conductive electrode (173α) made of carbon or corrosion resistant alloy is placed, which electrode (173α) is connected to the phase (F,158), through the electrical contact connector (169α), of the cable (175α) with insulation (170a) and of the timer [7b6 (TC)], wherein closing the circuit (127b6β) with [7b6 (TC)], Vac between the electrode (173α) and the metal chamber (B6α)is applied, setting the ions in the water in vibration, resulting in a rapid increase of the water temperature and subsequent rapid boil of the non-potable water in chamber (B6α) at a temperature <100° C., wherein the value of this temperature depends on the value of the water vapor pressure in chamber (B6α), resulting in the rapid production of water vapor which is transported from the outlet (4b6α) towardsvapor condensation mechanisms (Bz), (Yx).

1-10. (canceled)

11. The device for the conversion of non potable water into ecological drinking water, according to the present invention, is characterized in that the conversion device includes: a water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor and the vapor is moving to a freezing mechanism, comprising a serpentine with adjustable opening at the beginning with one-way non-return valve, for the condensation of water vapor and the water of the droplets in the second chamber returns to the first chamber or out of the system, a tank to supply the boiling chamber with non potable water, various mechanisms which flow air stream into and aut of the device, reducing the pressure exerted by the water vapor on the surface of non-potable water, as a result is the lowering of the water boiling temperature and the increase of the evaporation rate, one-way non-return valves, an ion trapping mechanism providing DC or AC to an electrical coil, generating magnetic fields, also supplying two metal plates, generating vertical electric field to the movement of vapor, thereby preventing the escape of ions, level control mechanisms with sensors and electromagnetic valves for water supply, a a current amplifier Am, to amplify the weak current due to the high electrical resistance of the water and an electromagnetic valve or a solinoid electrovalve comprising of a coil with an armature, a ring and a spring, to open the water flow to boiling chamber or to close the water flow when voltage is not applied, a sensor that detects the level of the water surface at the upper and lower limit of boiling chamber, a thermostat, with two levers and a rod, whose length is increased, by the temperature of water, thus interrupting the heating so that the flow of water is released towards the boiling chamber which lasts until the water surface comes in contact with the two pins of the sensor, two circuits which separately receive commands from the thermostat for supplying or stopping applied electrical power supply and when the first circuit is activated to fill the boiling chamber the second circuit for boiling remains inactive, wherein during the interruption power supply, controlled by a timer the filling of boiling chamber is performed automatically from various sources, while by the same thermostat a command is given to apply voltage releasing the flow of water to fill boiling chamber up to the upper limit, wherein the surface of non-potable water, meets the two sensors, wherein a command is given to the sensor to stop power supply two thermostats where the first with a lever and rod whose length is further increased, by water temperature, above the limit of boiling temperature, wherein the second is set to stop heating in temperatures <100° C., so that the temperature to stop electrical power supply for boiling, is adjusted by means of the first wherein during the interruption of power supply,at the same time the boiling chamber is filled with water from tank, by means of the second thermostat, receiving commands from a microprocessor in cooperation with a timer, where the function and all device settings are coordinated by a microcontroller and microprocessor, setting any preferred operating time for the mechanisms and valves, a single and dual functionality thermostats to stop operation at >100° C. and turn off power supply at threshold level and after a time period is ordered to descent floater in cooperation with the timer and one sensor, releasing the flow of water, mechanisms of air flow into boiling chamber, mechanisms of air flow free of oil channeling, air and water vapor into boiling chamber, chambers of separation of water droplets from vapor, a pressure gauge, water vapor cooling mechanisms, the freezing mechanism with its inner space filled with ice packs of high heat capacity, for the condensation of water vapor, through which space passes the pipeline with water vapor long and spacious with folds, double, grid-shaped,(streamers), on a horizontal surface or in the form of of cyclic coil, serpentines, spiral-shaped with vertical axis, (coil), surrounded by ice packs, so as to prevent the accumulation of water, the electrically heated resistances both internally and externally along the pipeline to avoid (prevent) ice development, fans that channeling cool air at a minimum distance from the pipeline below or above it, to accelerate the condensation of water vapor, which extracts heat transferred outside of the freezer, a sensor to interrupt the operation of the freezer in case of overheating, a compression mechanisms via which passes the pipeline with water vapor, mechanisms channeling air to layers with magnesium, potassium etc, In a container with water connected to the outlet pipe of the drinking water a water vapor is produced due to the vacuum, which passes through layers of magnesium, potassium and the like, which are transported to the chambers of drinking water, air cooling mechanisms with fans towards piping, a control mechanism for potable water levels, compression mechanisms and mechanisms transporting vapor water to boiling chamber, potable water release mechanism and brine release mechanism, a thermometer and a microprocessor or a microcontroller , the system which may be controlled by three timers, i) for the heating device, ii) for the suction pump and the fan that delivers cold air to serpentine tubes (pipes), iii) for the water vapor condensing system which may be a freezer and iv) by a sensor with an electromagnetic switch as a relay and a current amplifier (Am) that detects the level of the water surface at the upper and lower limit of boiling chamber, where no necessary by opening the tap of the chamber during operation of the device a stream of ambient air passes through the water so that the water is enriched in oxygen and others from the ambient air.

12. The device for the conversion of non potable water into ecological drinking water, according to claim 1, is characterized in that the device comprises of: three chambers for boiling water in the first chamber at temperature <100° C. in which a flow of atmospheric air stream, inlet into the boiling chamber through an aperture. by the help of an air absorbing mechanism, where this air stream is moving parallel to the surface of water inside the boiling chamber sweeping vapors to a second chamber into which the water droplets are separated from the vapor and the vapor is moving to a freezing mechanism comprising a serpentine with adjustable opening at the beginning with one-way non-return valve, for the condensation of water vapor and the water of droplets in the second chamber returns to the first chamber or out of the system, mechanisms free of oil channeling air and water vapor intake into the first chamber resulting in lowering boiling temperature and the increase of the evaporation rate, a mechanism for microwave emission into the boiling chamber, for rapid and low cost temperature rise, through dielectric heating, the circuits of power and duration of microwave emission, a mechanism and a fan cooling a chamber and the pipes inside transferring the water vapor, two outlets for escaping a larger amount of water vapor than that of one outlet, by opening the tap of the drinking water chamber, during operation of the device a stream of ambient air passes through the water so that the water is enriched in oxygen from the ambient air.

13. The device for the conversion of non potable water into ecological drinking water, according to claim 1, is characterized in that the device comprises of: a water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor and the vapor is moving to a freezing mechanism, comprising a serpentine with adjustable opening at the beginning with one-way non-return valve, for the condensation of water vapor and the water of the droplets in the second chamber returns to the boiling chamber or out of the system, an electric resistance in the boiling chamber for heating water, various mechanisms channeling air to boiling chamber, a second chamber and freezing mechanism a switch mechanism for electrical power supply for applying a voltage to electric resistance wherein a stem of a mechanism with automatic non-return valve and floater adjusted to terminate the flow of water, a thermostat with two levers which terminates electrical power supply if the lowest level is reached and initiates filling of boiling chamber and operation of freezing mechanism, two thermostats for power supply termination at temperature >90° C., full control of the level of water surface with a third sensor for the protection of electric resistance, a circuit that regulates the delay for the reopening of a valve, a power supply. wherein under the effect of the armor's magnetic field the circuit of the electromagnetic valve or a tubular electropump (222a) opens, or closes under the effect of the spring, a thermostat interrupts below 100°, where the boiling chamber is filled, and freezing mechanism is set to operation, taking command from microprocessor or microcontroller alike all other processes, wherein the length of rod in the thermostat increases with increasing water temperature above the limit temperature, moving the tip of thermostat lever to the left, interrupting the power supply onto the electric resistance, to open the flow of water towards boiling chamber, which lasts until the water level reach the essensor pins with consequent interruption of the water flow by means of the spring whose level starts to drop due to the water vapor outlet, a current amplifier to strengthen the weak current flowing running through the coil, due to the high electrical resistance of the water, by opening the tap of the drinking water chamber during operation of the device a stream of ambient air passes through the water so that the water is enriched in oxygen and nitrogen from the ambient air.

14. The device for the conversion of non potable water into ecological drinking water, according to claim 1, is characterized in that the device comprises of: three chambers for boiling water at temperature <100° C. in the first chamber, in which a flow of atmospheric air stream, inlet into the boiling chamber through an aperture. by the help of an air absorbing mechanism, where this air stream is moving parallel to the surface of water inside the boiling chamber sweeping vapors to a second chamber into which the water droplets are separated from the vapor and the vapor is moving to a freezing mechanism comprising a serpentine with adjustable opening at the beginning, with one-way non-return valve, for the condensation of water vapor and the water of droplets in the second chamber returns to the first chamber or out of the system, mechanisms free of oil channeling air and water vapor intake into the first chamber resulting in lowering boiling temperature and the increase of the evaporation rate, a mechanism as a heat source, by applying a voltage, onto two electrodes the first inside boiling water in the first boiling chamber and the second outside for heating water, which is achieved by the vibration of the ions, which follow the alternating polarity of the electrical field, wherein the temperature and pressure are controlled by means of a thermostat, a pressure gauge and air flow mechanisms inside the boiling chamber, on which pressure depends the boiling temperature and the evaporation rate of non-potable water, based on the BERNOULLI principle, having as a consequent the control of produced volume and quality of drinking water, as at pressure of 700 mbar the boiling temperature is 90° C. and at a pressure of 210 mbar, the boiling temperature is 60° C., a piping system for the transport of water vapor, by opening the tap (25) of the drinking water chamber during operation of the device a stream of ambient air passes through the water so that the water is enriched in oxygen and nitrogen from the ambient air.

15. The device for the conversion of non potable water into ecological drinking water, according to claim 1, is characterized in that the device comprises of: various other types of chambers for potable water collection, to be improved, wherein the first chamber has a frustoconical shape, with a rubber cap a tube for channeling vapor and potable water, where in the form of water vapor in the tube for the transfer to said mechanisms of compression, transmission and freezing mechanism or via airflow mechanism to water boiling chamber for boiling at temperature <100° C. in which a flow of atmospheric air stream, inlet into the boiling chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve and the vapor is moving to a freezing mechanism comprising a serpentine with adjustable opening at the beginning with one-way non-return valve, for the condensation of water vapor and the water of droplets in the second chamber returns to the first chamber or out of the system, mechanisms free of oil channeling air and water vapor intake into the first chamber resulting in lowering boiling temperature and the increase of the evaporation rate, or in the form of water vapor for the transfer to the tank and in the form of drinking water which is collected in drinking water chambers, wherein the second chamber has the side walls as curved surfaces with a rubber cap, wherein the third chamber has the side walls as cylindrical surfaces, with a rubber cap, wherein the fourth chamber has the side walls as cylindrical surfaces, with a cap resting on an sheet made of elastic material and clogging the nozzle, by opening the tap (25) of the chamber G5(5d) during operation of the device a stream of ambient air passes through the water so that the water is enriched in oxygen and nitrogen from the ambient air. by opening the tap of the chamber drinking water, during operation of the device a stream of ambient air passes through the water so that the water is enriched in oxygen and nitrogen from the ambient air.

16. The device for the conversion of non potable water into ecological drinking water, according to claim 1, is characterized in that the device comprises of, a water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve and the vapor is moving to a freezing mechanism for the condensation of water vapor and the water of the droplets in the second chamber returns to the first chamber or out of the system, a tank to supply the boiling chamber with non potable water, various mechanisms which flow air stream into and aut of the device, reducing the pressure exerted by the water vapor on the surface of non-potable water, as a result is the lowering of the water boiling temperature and the increase of the evaporation rate, where the boiling chamber has a lower cylindrical surface and an upper turnaround surface for directing the water vapor to a second chamber where the water droplets are separated, to a third chamber with cooling mechanism, to a freezing mechanism and collecting the drinking water in chamber, a mechanism of air flow inside to the boiling chamber and the mechanisms of air flow inside to the second chamber to remove quicker water vapor, to lower boiling temperature, a transfer mechanism for water vapor transfer to a third chamber with cooling mechanism and to a freezing mechanism, a thermostat which interrupts heating supply at temperature <100° C., alternatively, an improved model of the above system for even greater increase in the quantity of water vapor, comprises of: a boiling chamber with a lower cylindrical surface and an upper double turnaround surface, with two exits to the pipes carrying the water vapor, to facilitate escape of even larger amounts of water vapor, where a heat production mechanism with a thermostat is in contact with the external bottom surface of the boiling chamber heating externally the non-potable water.

17. The device for the conversion of non potable water into ecological drinking water, according to claim 1, is characterized in that it comprises of: an outer chamber and an inner water at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve, fo for the condensation of water vapor and the water of the droplets in the second chamber returns to the first chamber or out of the system, a tank to supply the boiling chamber with non potable water, various mechanisms which flow air stream into and out of the device, reducing the pressure exerted by the water vapor on the surface of non-potable water, as a result is the lowering of the water boiling temperature and the increase of the evaporation rate, where the two chambers have a common bottom made of transparent glass, for radiation of wave length at 2.8 μm matching the top of the water absorption spectrum, a heating mechanism connected to electrical power applied to a quartz heater which is filled with inert gas, an electric coil as the ohmic heating resistance, one quartz rod, a reflector so that radiation tends to double, wherein applying Vac to said electric coil causes the glow of said quartz rod, which stimulates the silicon-oxygen bonds of the quartz, to transmit electromagnetic radiation of 1.0 μm to 3.1 μm, causing the boiling of water, where various mechanisms which flow air stream into and aut of the device, feed air stream and water vapor inside said boiling chamber and second chamber for separating water droplets resulting in water boiling at a temperature <100° C. and rapid production of water vapor, alternative types of heaters, such as a rod C and thread C made of quartz (1.3 μm-3.1 μm), at 1000° C., with made of refractory ceramic 300° C. to 700° C., producing radiation from 1.0 μm to 10.0 μm.

18. The device for the conversion of non potable water into ecological drinking water, according to claim 1, characterized in that the device comprises of: a water (Is), at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve and the water of the droplets in the second chamber returns to the first chamber or out of the system, a tank to supply the boiling chamber with non potable water, various mechanisms which flow air stream into and aut of the device, reducing the pressure exerted by the water vapor on the surface of non-potable water, as a result is the lowering of the water boiling temperature and the increase of the evaporation rate, where a heating mechanism that brings water to boiling at temperatures <100° C., an electric coil surrounding a tubular ceramic to which Va.c. is applied producing an alternating magnetic field, (amf), inside the cavity of the tubular ceramic, which sets ions into alternate movement (a.m.), causing heating of water so that it brings it to boiling at temperatures <100° C., resulting in the economical and rapid production of water vapor, which is transferred via the second chamber to a third chamber with cooling mechanism and to a freezing mechanism, mechanisms who feed air stream into the boiling chamber, thus reducing the boiling point and increasing the speed for rapid production of water vapor, a mechanism which channels flow of air molecules with water vapor, into the boiling chamber, a thermostat to interrupt heating at temperatures <100° C., a microprocessor that coordinates the operation of the system, wherein alternatively the system comprises of a single electric coil without a tubular ceramic, a conventional ohmic resistance and another form of ohmic resistance such as a saw resistance.

19. The device for the conversion of non potable water into ecological drinking water, according to claim 1, is characterized in that the device comprises of:
an external chamber and an internal water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve, for the condensation of water vapor and the water of the droplets in the second chamber returns to the first chamber or out of the system, a tank to supply the boiling chamber with non potable water, various mechanisms which flow air stream into and aut of the device, reducing the pressure exerted by the water vapor on the surface of non-potable water, as a result is the lowering of the water boiling temperature and the increase of the evaporation rate, a mechanism providing electric power to a halogen lamp heater, a tube made of Si with I or Br, and one W thread whose ends are connected to Face, Nutral, wherein applying Vac causes threads to glow, and emit electromagnetic radiation in wave lengths between 1.0 μm and 3.1 μm for rapid production of water vapor, which is cooled by the freezing mechanism to be liquefied, and the produced water flows into drinking water chamber, a mechanism which channels air into the boiling chamber with water vapor, which has not been liquefied, a microprocessor which coordinates the operation of the whole system, with the halogen lamp showing another aspect when rotated around the axis by 90° degrees.

20. The device for the conversion of non potable water into ecological drinking water, according to claim 1, is characterized in that the device comprises of: an external chamber and an internal water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve, for the condensation of water vapor and the water of the droplets in the second chamber returns to the first chamber or out of the system, a tank to supply the boiling chamber with non potable water, various mechanisms which flow air stream into and aut of the device, reducing the pressure exerted by the water vapor on the surface of non-potable water, as a result is the lowering of the water boiling temperature and the increase of the evaporation rate, where the water boiling chamber has a metal bottom which is heated by an ohmic resistance a mechanism supplying electric power (Pe) to the ohmic resistance via an electric relay a Vac is applied to ohmic resistance, for production of water vapor, which is cooled by the freezing mechanism to be liquefied, and the produced water flows into drinking water chamber alternatively, the system comprises of: an external chamber and an internal water boiling chamber at temperature <100° C. in which a flow of atmospheric air stream, inlet into the chamber through an aperture. by the help of an air absorbing mechanism, where this air stream is moving parallel to the surface of water inside the boiling chamber sweeping vapors to a second chamber into which the water droplets are separated from the vapor (due to gravity) and the vapor is moving to a freezing mechanism comprising a serpentine with adjustable opening at the beginning with one-way non-return valve, for the condensation of water vapor, where a metal chamber on the bottom of which are placed in two insulated bases and two carbon electrodes to which applying Vac sets ions within water to vibrate, thereby producing vapor, alternatively the metal chamber is connected as an electrode to the Nutral, wherein on the base the carbon electrode is positioned, which is connected to Face, wherein applying Vac between carbon electrode and metal chamber ions are set to vibration, resulting in the production of water vapor.
